(19) United States
(12) Patent Application Publication
(10) Pub. No.: US 2002/0174329 A1
(43) Pub. Date: Nov. 21, 2002

(54) Method and system for automatically transitioning files among computer systems

(76) Inventors: Richard A. Bowler, Portland, OR (US); James R. Hines, Scappoose, OR (US); Kenneth J. Mackin, Beaverton, OR (US)

Correspondence Address: Stephen Lesavich, McDonnell Boehnen Hulbert & Berghoff, 32nd Floor, 300 S. Wacker Drive, Chicago, IL, 60606, US

(21) Appl. No.: 09/793,334

(22) Filed: Feb. 26, 2001

Related U.S. Application Data
(63) Continuation-in-part of application No. 09/300,862, filed on Apr. 28, 1999.

(51) Int. Cl. G06F 15/177; G06F 9/00; G06F 9/24

(52) U.S. Cl. 713/1

(57) ABSTRACT

A method and system for automatically transitioning files among computer systems. A predetermined set of file transition rules and/or a list of selected files from a directory hierarchy on a source computing system are obtained and used to extract one or more files from one or more locations on the source computing system. The pre-determined set of file transition rules can be used for a mass transition of many different files from many different source computers and is independent of actual file systems on the source computers. The list of selected files from the directory hierarchy can be used for a single transition and is dependent on an actual file system on a source computing system. A transition package is created including the extracted files to automatically transition files. The method and system may vastly reduce file transition, configuration and deployment times when a new computing system is deployed.

### CROSS REFERENCES TO RELATED APPLICATIONS

This application is a Continuation-In-Part of U.S. Application No. 09/300,862 filed on Apr. 28, 1999.

### COPYRIGHT AUTHORIZATION

A portion of the disclosure of this patent document contains material, which is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE INVENTION

The present invention relates to configuration of computers. More specifically, it relates to a method and system for automatic transitioning of files among computer systems.

### BACKGROUND OF THE INVENTION

In today's world, where technology changes very quickly, it is very common to replace an old computer system every few years with a new computing system. It has been estimated that approximately 90,000,000 personal computers are sold each year, with approximately 90% of the sales comprising new computing systems to replace old computing systems. The new computing systems typically include more memory, larger hard-disks, faster central processing units, better quality monitors, updated versions of operating systems, new software applications and other improved features.

Any old computer system typically includes a large number of configuration settings that have been added and/or customized by a user or a network manager. The configuration settings may include Internet settings, modem or other network settings, dial-up phone numbers, a desktop “look and feel,” file system folders settings, application settings, folder names and locations, macros and editing options, custom dictionaries, electronic mail (“e-mail”) address books, inboxes, passwords, subscriptions, certificates and other configurations or setting customized by a user or a network manager, or other configuration parameters used over time such as cookies, etc.

There are several problems associated with making a transition from an old computing system to a new computing system. First, there is currently no easy way to determine what configuration settings a user or a network administrator may have customized, since there is no one central location where such configuration files are stored. Operating systems and other hardware and software applications typically have unique directories and unique file names to store configuration files and settings. These unique directories and configuration files can exist virtually anywhere on an old computer system. Trying to collect configuration settings is a difficult task. The average user or network administrator may have to spend large amounts of time reading documentation or help screens to figure out where the configuration files are stored for any given application.

Another problem is that there is no easy way to collect and store heterogeneous configuration settings when they are located. The operating system and applications typically use unique data layouts and data storage features that do not allow for homogenous collection and storage.

Another problem is that there is no easy way to transfer old configuration settings to a new computing system. When a new computer system is used, a user or a user's agent typically has to re-configure the new computing system to include configuration settings that were used on an old computer system. All but the most rudimentary pieces of “the migration process” are done by hand. This requires many hours of hands-on time, with lost productivity and a “start from scratch” resignation. Many users often decide to stick with an obsolete old computer system rather than wrestle migration and manual re-configuration required for a new computing system.

Yet another problem is that configurations settings on an old computing system may be stored in a new location, in a new file, or in new format on a new computing system. An old configuration setting may have to be translated or otherwise modified to provide the same results on the target computing system. Such translation and/or modifications are typically completed by hand and are prone to errors that lead to user frustration.

Yet another problem is that the migration to a new computing system typically requires training on new features of new target computing system before migration can take place. This training often delays the migration process. In addition, a manual migration process used without adequate training on the new computing system can decrease quality of service on the new computing system since one or more configuration settings may be missed on the old computing system and not be transferred to the new computing system.

Yet another problem is that files other than configuration files, created or associated with various other types of applications such as document files, picture files, movie files, audio files, video files, etc., also need to be transitioned to a new computing system.

Yet another problem is that is it often difficult to first determine and then select such files associated with various types of applications to transition from a old computing system to a new computing system. A user who is transitioning from an old computing system to a new computing system typically has to first determine what types of files to transition, and then try to determine the location of such files on the old computing system. The selection process for such files is often tedious and frustrating. If such a process is not done carefully, it is easy to miss or forget files that a user desires to transfer from an old computing system to a new computing system.

Thus, it is desirable to automatically determine and select files from transition from an old computing system to a new computing system. It is also desirable to provide an automatic migration of such files from an old computing system to a new computing system without using a time-consuming manual selection, location and migration process.

### SUMMARY OF THE INVENTION

In accordance with preferred embodiments of the present invention, some of the problems associated with transferring files from an old computer system to a new computer system are overcome. A method and system for automatically transitioning files among computer systems is provided.

One aspect of the invention includes a method for automatically transitioning files from a source (i.e., old) computing system to a target (i.e., new) computing system using file transition rules. The predetermined set of file transition rules are typically used for, but not limited to, a mass transition of many different files from many different source computers and is independent of actual file systems on the source computing systems.

Another aspect of the invention includes a method for automatically transitioning the files using a list of files selected from a directory hierarchy. The list of selected files from the directory hierarchy is typically used for, but is not limited to, a single transition and is dependent on an actual file system structure on a source computing system.

The file transition rules and the list of files selected from a directory hierarchy can also be used in combination to transition files from a source computing system to a target computing system.

The method and system provide an automated transition process for transition of files from a source computing system to a target computing system. The method and system may vastly reduce transition, configuration and deployment times for files for service providers, corporations, and end-users for transitions from a source computing system to a target computing system. The method and system may save time, resources, improve transition quality, and reduce user frustration.

The foregoing and other features and advantages of preferred embodiments of the present invention will be more readily apparent from the following detailed description. The detailed description proceeds with references to the accompanying drawings.

### BRIEF DESCRIPTION OF THE DRAWINGS

Preferred embodiments of the present invention are described with reference to the following drawings, wherein:

FIG. 1 is a block diagram illustrating an exemplary translation system;

FIG. 2 is a block diagram illustrating an exemplary layered transition architecture;

FIG. 3 is a flow diagram illustrating a method for automatically determining transition configuration settings from a source computing system for a target computing system;

FIG. 4 is a block diagram illustrating components of a Personality object;

FIG. 5 is a flow diagram illustrating a method for automatically applying determined transition configuration settings;

FIGS. 6A and 6B are flow diagram illustrating a method for automatically transitioning configuration settings;

FIG. 7 is a block diagram illustrating a data flow for the automatic configuration setting transition method of FIGS. 6A and 6B;

FIG. 8 is a flow diagram illustrating a method for automatically transitioning files from a source computing system to a target computing system using file transition rules;

FIG. 9 is a flow diagram illustrating a method for automatically transitioning files from a source computing system to a target computing system using a directory hierarchy;

FIG. 10 is a block diagram visually illustrating an exemplary exposure of an exemplary eligible file system of a source computer system; FIGS. 11A and 11B is a flow diagram illustrating a method for automatically transitioning files from a source computing system to a target computing system using file transition rules and a list of files from a directory hierarchy;

FIGS. 12A and 12B are a flow diagram illustrating a method for selecting file transition rules or files from a directory hierarchy for transition;

FIG. 13 is a block diagram illustrating a graphical screen display for transitioning files;

FIG. 14 is a block diagram illustrating a graphical screen display for creating a pre-determined set of file transition rules; and

FIG. 15 is a block diagram illustrating a graphical screen display for selecting files from a directory hierarchy.

### DETAILED DESCRIPTION OF PREFERRED EMBODIMENTS

Exemplary Transition System

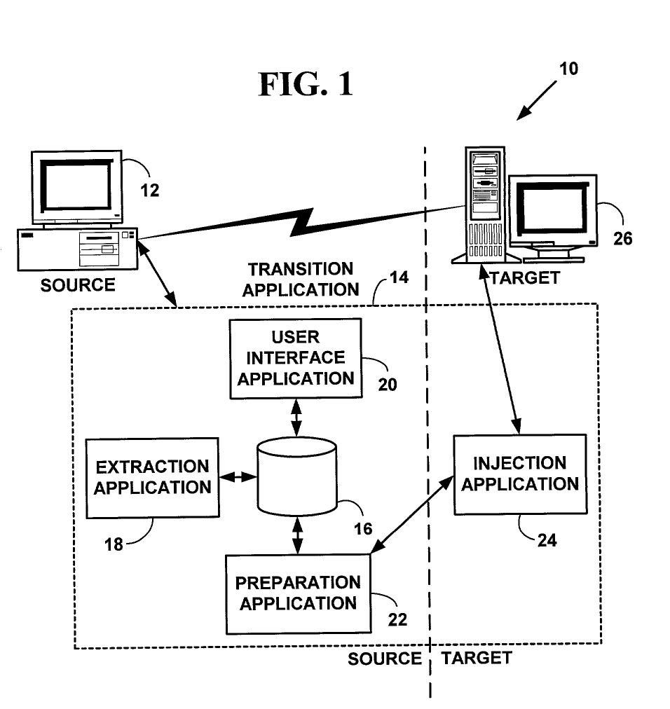

FIG. 1 is a block diagram illustrating an exemplary transition system 10 for automatically transitioning configuration settings from a source (i.e., old) computing system to a target (i.e., new) computing system. The transition system 10 includes a source computing system 12. The source computing system 12 uses a Transition application 14. The Transition application 14 comprises: a database 16, an Extraction application 18, a User Interface application 20, and a Preparation application 22. The Transition application 14 further comprises an Injection application 24 that is sent to a target computing system 26.

The source computing system 12 and the target computing system 26 are illustrated as desktop computers. However, The source computing system 12 and target computing system 26 can also include laptop computers, wireless devices, mobile phones, mobile devices, personal digital assistants (“PDA”), hand-held computers, Internet appliances or other types of electronic devices. Nevertheless, more, fewer or equivalent components could also be used in the transition system 10, including intermediate computing systems or computer networks (e.g., the Internet or an intranet, etc.) between the source computing system 12 and the target computing system 26, and the present invention is not limited to the components illustrated in FIG. 1. In addition, the Transition application 14 can also exist on an intermediate computing node (e.g., an Internet or an intranet server) and not exist directly on either the source computing system 12 or the target computing system 26.

In one exemplary preferred embodiment of the present invention, the database 16 is used for storing configuration settings extracted from the source computing system 12, manipulated configuration settings, transition plans and transition packages to transition configuration settings from the source computing system 12 to a target computing system 26. The database 16 may include data stored in a database format or in other formats such as a data structure format, a file format, or other volatile or non-volatile storage formats. The Extraction application 18 is used for locating and extracting configuration settings on the source computing system 12 to transition to the target computing system 26. The User Interface application 20 is used for preparing an extraction plan and a transition plan to extract and transition configuration settings from the source computing system 12 to the target computing system 26. The Preparation application 22 is used for manipulating configuration setting extracted from the source computing system 12 and for preparing a transition package. The transition package is used to transition configuration settings from the source computing system 12 to the target computing system 26. The Injection application 24 is used for infusing manipulated configuration settings from a transition package to transition configuration settings from the source computing system 12 to a target computing system 26. However, the present invention is not limited to the functionality described for the transition applications, and the transition applications can include more, less or equivalent functionality. The transition applications are explained in detail below.

In one embodiment of the present invention, the Transition application 14 including the database 16, the Extraction application 18, the User Interface application 20, and the Preparation application 22 without the Injection application 24 reside on the source computing system 12. This is illustrated in FIG. 1 by the dashed line dividing source and target components of the Transition application 14. In such an embodiment, only the Injection application 24 resides on the target computing system 26.

In another preferred embodiment of the present invention, a Transition application 14 including a database 16, an Extraction application 18, a User Interface application 20, and a Preparation application 22, and an Injection application 24 resides on both the source computing system 12 and the target computing system 26 (not illustrated in FIG. 1).

In another preferred embodiment of the present invention, the source computing system 12 only temporarily includes the Transition application 14. That is, the Transition application 14 is not installed on any non-volatile storage on the source computing system 12. The Transition application 14 only “resides” in volatile storage (e.g., Random Access Memory (“RAM”)) on the source computing system 12 during the extraction and preparation portion of the transition process. The target computing system 26 may also only temporary include the Injection application 24. The Injection application 14 may also only reside in volatile storage on the target computing system 14 during the injection portion of the translation process.

In yet another embodiment of the present invention, components of the Translation application 14, or the whole Translation application 14 may only exist on a “third” computing system and not on either the source computing system 12 or the target computing system 14. Additional software applications may be used only to retrieve and only to inject settings and such software applications would be present only temporarily on the source computing system 12 or the target computing system 14 and coordinated from the third computing system. In yet another embodiment of the present invention, computer software, hardware or firmware may be employed in such a manner that configuration settings are extracted and injected without a software Transition application 14 existing on either the source computing system 12 or the target computing system 14.

In yet another preferred embodiment of the present invention, the source computing system 12 may only include the Extraction application 18. The other components of the Transition application 14 reside on one or more other computing systems and can be used in a distributed fashion. Extracted transition data can also be stored on the one or more other computing systems using distributed computing. An operating environment for the computing systems 12, 26 of the present invention include a processing system with one or more high speed Central Processing Unit(s) (“CPU”) and a memory system. In accordance with the practices of persons skilled in the art of computer programming, the present invention is described below with reference to acts and symbolic representations of operations or instructions that are performed by the processing system. Such acts and operations or instructions are referred to as being “processor-executed,” “computer-executed” or “CPU executed.” The CPU can be either electrical or biological. The acts and symbolically represented operations or instructions include the manipulation of electrical signals or biological signals by the CPU. An electrical system or biological system represents data bits that cause a resulting transformation or reduction of the electrical signals or biological signals. The maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to the data bits.

The data bits may also be maintained on a computer readable medium including magnetic disks, optical disks, electrical memory, organic memory, and any other volatile (e.g., Random Access Memory (“RAM”)) or non-volatile (e.g., Read-Only Memory (“ROM”) a hard disk, etc.,) mass storage system readable by the CPU. The computer readable medium includes cooperating or interconnected computer readable medium, which exist exclusively on the processing system or be distributed among multiple interconnected processing systems that may be local or remote to the processing system.

Exemplary Transition Architecture

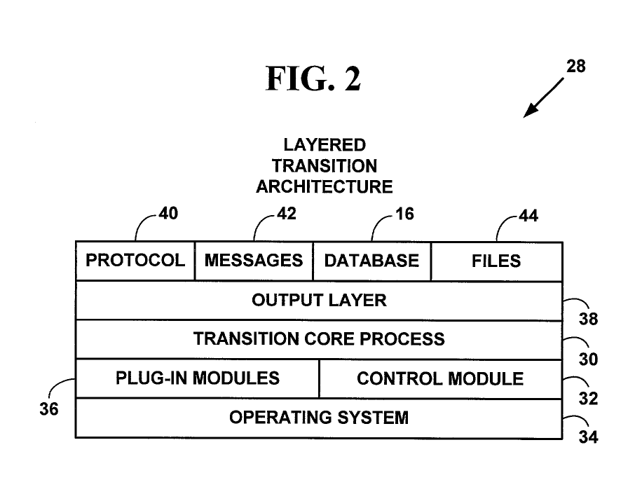

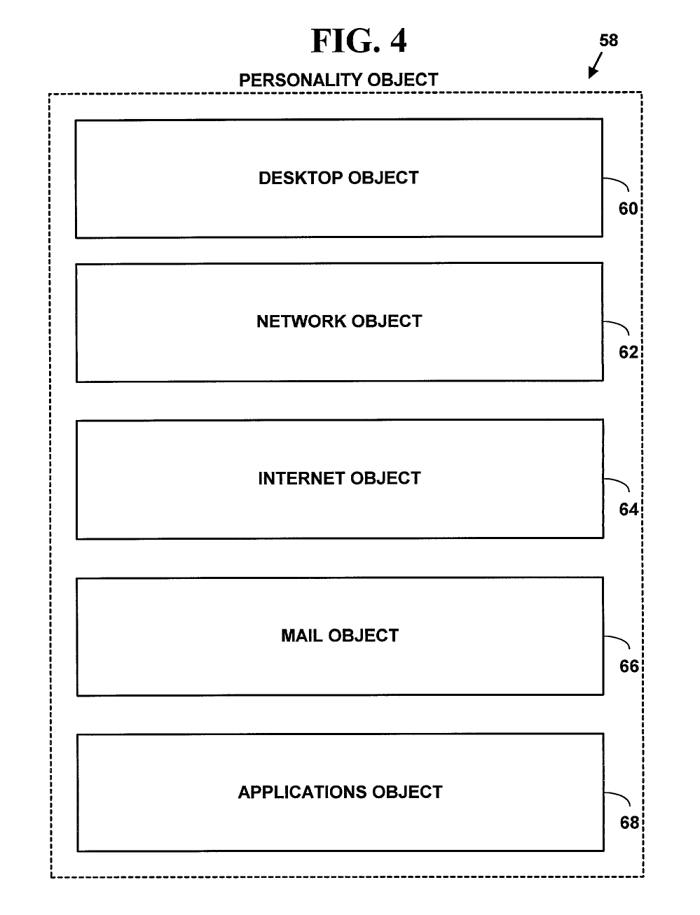

FIG. 2 is a block diagram illustrating an exemplary layered transition architecture 28 for the Transition application 14 of FIG. 1. The Transition application 14 resides in a transition core process 30. The transition core process 30 includes a control module 32 that is an interface to an operating system 34. The operating system 34 can be a windowed operating system such as Windows 95/98/ME/NT/2000 by Microsoft Corporation of Redmond, Wash., and other windowed or non-windowed operating systems can also be used (e.g., Linux, UNIX, etc.). The transition core process 30 uses plug-in modules 36 to interface to the operating system 34 and to process configuration settings from the source computing system 12. The plug-in modules 36 also allow additional modules to be added to provide new and enhanced functionality for the transition core process 30. The plug-in modules 36 are explained below (See FIG. 4).

In one exemplary preferred embodiment of the present invention, a first transition core process 30 on the source computing system 12 controls the Extraction application 18 (FIG. 1), the User Interface application 20 (FIG. 1), and the Preparation application 22 (FIG. 1). The operating system 34 on the target computing system 26 controls execution of the Injection application 24 on the target computing system 26 (e.g., the Injection application 24 is an executable file (.EXE)). In another exemplary preferred embodiment of the present invention, a first transition core process 30 on the source computing system 12 controls the Extraction application 18, the User Interface application 20, and the Preparation application 22. A second transition core process 30 on the target computing system 12 controls a first Injection application 24 on the target computing system 26.

In one exemplary preferred embodiment of the present invention, the transition core process 30 includes an Application Prograrnmer's Interface (“API”). The transition API allows other applications to call transition application functions (e.g., Hyper Text Markup Language (“HTML”), Extensible Markup Language (“XML”), Wireless Markup Language (“WML”), Java, Java Script, Visual Basic (“VB”), Visual Basic Scripts, C++, Visual C++, etc.). The transition API also includes functions for low level Input/Output (“I/O”), high level I/O, and smart I/O. The low level I/O includes functions for file system I/O, database 16 interaction, transition specific I/O, operating system registry I/O, etc. The high level I/O includes retrieval of configuration settings, storage of configuration settings, etc. The smart I/O includes smart configuration setting searching capabilities, smart copying capabilities, etc.

The transition core process 30 includes an output layer 38, a protocol layer 40, a message layer 42, a database 16 and a file layer 44. The output layer 38 is used for the various types of I/O as was described above. The protocol layer 40 allows the transition core process 30 to use protocols such as Hyper Text Transfer Protocol (“HTTP”), File Transfer Protocol (“FTP”), User Datagram Protocol (“UDP”), Transmission Control Protocol (“TCP”), Internet Protocol (“IP”), Wireless Application Protocol (“WAP”), and other protocols to communicate with the source computing system 12 and the target computing system 26. The message layer 42 is used for electronic mail (“e-mail”) and other communications with the operating system 34 and the source computing system 12 and the target computing system 26.

The database 16 includes objects used to locate configuration settings on the source computing system. The database 16 may be temporary storage such as RAM, or permanent storage such as a floppy disk, hard disk, re-writeable, CD-ROM, Flash memory, Flash-ROM, or other non-volatile computer readable media. The file layer 44 includes configuration settings extracted from the source computing system 12. The file layer 44 also allows files to be created and retrieved across file volumes including local and remote file systems. However, more, fewer or equivalent layers could also be used in the translation architecture 28. The present invention is not limited to the architecture layers illustrated in FIG. 2.

Automatic Transition of Configuration Settings

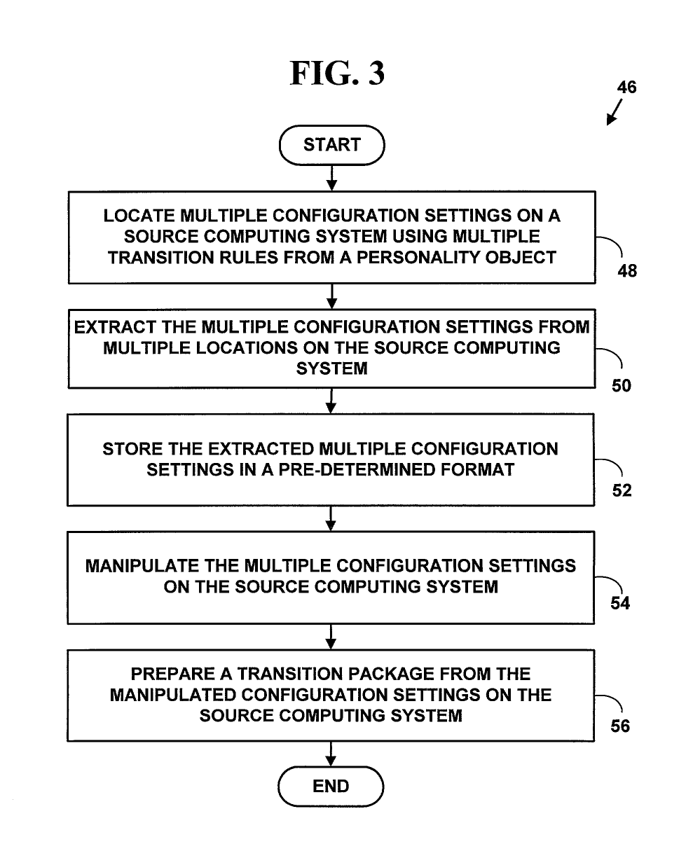

FIG. 3 is a flow diagram illustrating a Method 46 for automatically transitioning configuration settings from a source computing system to a target computing system. At Step 48, multiple configuration settings are located on a source computing system using multiple transition rules from a Personality object. At Step 50, multiple configuration settings are extracted from multiple locations on the source computing system. At Step 52, the multiple extracted configuration settings are stored in a predetermined transition format. At Step 54, the multiple extracted configuration settings stored in the pre-determined transition format are manipulated. At Step 56, a transition package is created from the multiple manipulated configuration settings. The transition package includes the multiple manipulated configuration settings. The transition package is sent from the source computing system to the target computing system or stored as an intermediate step in the transition process. The transition package may also be stored one or more intermediate computing systems, local or remote to the source computing system or the target computing system. The transition package is infused on the target computing system to transition configuration settings from the source computing system to a target computing system.

Preferred embodiments of the present invention use object-oriented programming techniques. However, non-object-oriented programming techniques could also be used. As is known in the art, an “object type,” also called an “object class,” comprises a data-type, services that operate on instances of the data type, and a set of object attributes in an object-oriented data-structure. An “object attribute” is a field of data in an object that partially defines that object's state. An “object service” implements and manipulates objects, usually by reading or changing the object attributes. “Object-oriented design” is a software development technique in which a system or component is expressed using objects.

An object typically is an object-oriented data-structure that has two components: a function table, containing a pointer to each “object member” or member function (i.e., sometimes known as an “object method”) defined in the object's class, an events table, for accepting events (e.g., OLE or ActiveX control events) and a data block, containing the current values for each object variable (i.e., data members, sometimes known as an “object property”). A computer software application has some reference to an object through an object pointer. A computer software application obtains this object reference by using some type of function call (direct or implied) in which that function allocates an object block in computer memory, initializes the function table, and returns a reference to allocated computer memory to an application. The computer memory may be local or distributed on a remote computer.

The Component Object Model (“COM”) and Distributed Component Object Model (“DCOM”) are models used for object-oriented programming and known to those skilled in the art. The COM and DCOM specify how objects within a single application or between applications (e.g., client/server applications) interact and communicate by defining a set of standard interfaces. Interfaces are groupings of schematically related functions through which a client application accesses the services of a server application.

Object controls, such as Object Linking and Embedding (“OLE”) controls and ActiveX Controls by the Microsoft Corporation of Redmond, Wash., are based in part on the Component Object Model. Such object controls allow the creation of objects of different formats, which operate on data through defined interfaces, rather than operating on the applications responsible for the data. ActiveX is based in part on OLE technologies. An OLE control or ActiveX control is an object control that accepts and responds to events, such a selection input from a mouse or a key on a keyboard, or a selection by another object-oriented member function. Detailed information on the OLE object interface and OLE controls can be found in Inside OLE, 2nd edition, by Kraig Brockschmidt, Microsoft Press, Redmond Wash., 1995, which is incorporated herein by reference.

In an exemplary preferred embodiment of the present invention, at Step 48, multiple configuration settings are located on the source computing system 12 using multiple transition rules from a Personality object. In an exemplary preferred embodiment of the present invention, the Personality object includes five object-oriented plug-in modules 36. However, more, fewer or equivalent object-oriented plug-in modules 36 could also be used.

Translation Personality Object

FIG. 4 is a block diagram illustrating components of an exemplary Personality object 58. The Personality object 58 includes a Desktop object 60, a Network object 62, an Internet object 64, a Mail object 66 and an Applications object 68. However, more, fewer or equivalent objects could also be used in the Personality object 58. The objects include information about configuration settings such as location, name, associated sub-settings, etc. In an exemplary preferred embodiment of the present invention, the objects 60, 62, 64, 66, 68 in the Personality object 58 are object-oriented objects. However, non-object oriented objects could also be used in the Personality object 58. The Personality object 58 and related objects 60, 62, 64, 66, 68 comprise object classes that include one or more object members and a data block as was described above.

In one exemplary preferred embodiment of the present invention, the Desktop object 60 includes user preferences that affect the appearance and operation of a basic windowed user interface. Exemplary configuration settings included in the Desktop object 60 are illustrated in Table 1. However, more, fewer or equivalent configuration settings can also be used in the Desktop object 60, and the present invention is not limited to the configuration settings illustrated in FIG. 1.

TABLE 1
Desktop Object 60

Visual Elements
Fonts including meta-data colors, themes, sounds, password

wall paper, screen savers, metrics, etc.

Accessibility Elements
Settings that disable accessibility to the source computing

system 12

User Interface Hardware Settings
Display resolutions, mouse trails, keyboard mappings,

character settings, etc.

```
Regional Settings
    Time zones, data formats, language, currency settings, etc.
Windows Preferences
    Start menus, desktop shortcuts, document and run
```

commands, etc.

Registry Settings

The Network object 62 includes configuration settings that enable functionality within a private network of computers such as a Local Area Network (“LAN”) or an intranet. In one exemplary preferred embodiment of the present invention, the Network object 62 may not include hardware configuration settings. The Network object 62 may instead include configuration settings that configure the operating system 34, that in turn are mapped to underlying hardware on the source computing system 12. In another exemplary preferred embodiment of the present invention, the network object 62 may include hardware settings.

Exemplary configuration settings included in the Network object 62 are illustrated in Table 2. However, more, fewer or equivalent configuration settings can also be used in the Network object 62, and the present invention is not limited to the configuration settings illustrated in Table 2.

TABLE 2
Network Object 62

```
Service Providers
    Name, network addresses (e.g., IP address), dial-up numbers,
    etc.
Services
    Network services, DSL, cable modem, satellite, wireless, etc.
Clients
    Proxies, network servers, etc.
Domains
    Domain names and subnets, workgroups
Protocols
    TCP, UDP, IP, HTTP, FTP, WAP, etc.
Registry Settings
```

The configuration settings from the Network Object 62 are applied to the target computing system 26 within the context of operating system 34 services available on the target computing system 26. In one exemplary preferred embodiment of the present invention, the Network Object 62 will not install configuration settings for network applications that are not available on the target computing system. For example, if the source computing system 12 has TCP/IP installed, the Network Object 62 will locate and extract relevant TCP/IP settings from the source computing system 12. If the target computing system does not have TCP/IP installed, the Network Object 62 will not automatically transition the TCP/IP settings from the source computing system 12, since the TCP/IP settings can not be used. In another embodiment of the present invention, if the source computing system 12 has configuration settings for a network application that is not installed on the target system (e.g., TCP/IP) the network application will be installed on the target computing system and the appropriate configuration settings will then be applied.

Another feature of the Network Object 62 is to allow a user to review and edit configuration settings before they are applied to the target computing system 26. For example, a network address (e.g., an IP address) extracted from the source computing system may or may not be appropriate for the target computing system, since the target computing system may be installed on a different computer network. Thus, the user can review and edit the configuration settings before they are applied to the target computing system 26.

The Internet Object 64 includes configuration settings that are relevant to the public network of computers provided by the Internet. As is know in the art, the Internet is a world-wide network of inter-connected computers. Exemplary configuration settings included in the Internet object 64 are illustrated in Table 3. However, more, fewer or equivalent configuration settings can also be used in the Internet object 64, and the present invention is not limited to the configuration settings illustrated in Table 3.

TABLE 3
Internet Object 64

```
Accounts
    Internet service provider accounts, logins, passwords, etc.
Internet Browser
    Internet Explorer, Netscape Navigator, etc.
Internet browser options
    Favorites, addresses (i.e., Uniform Resource Locators
      (“URL's”), cookies, bookmarks, histories,
      newsgroup filters, security settings, channels, certificates, etc.
Dial-up networking settings
    Dial-up numbers, login names, passwords, etc.
Network addresses
    IP addresses, etc.
Registry settings
```

The Mail object 66 includes configuration settings for electronic mail (“e-mail”) and other communication messaging used on the old computer system 12. In one exemplary preferred embodiment of the present invention, the Mail object 66 includes configuration settings for Exchange, Outlook and Outlook Express, by Microsoft, Communicator, by Netscape Corporation of Mountain View, Calif., Pegasus, Eudora, and Lotus Notes, by IBM. However, more, fewer or equivalent e-mail or communications programs could also be supported by the Mail object 66, and the present invention is not limited to the e-mail and communications programs listed. Exemplary configuration settings included in the Mail object 66 are illustrated in Table 4. However, more, fewer or equivalent configuration settings can also be used in the Mail object 66, and the present invention is not limited to the configuration settings illustrated in Table 4.

TABLE 4
Mail Object 66

```
E-mail, communication applications
    Express, Outlook, Outlook Express, Communicator,
    Pegasus, Eudora, Lotus Notes, etc.
Settings
    E-mail address identification, address books,
    inbox/outbox folders, mail folders, etc.
Meta Data
    Custom dictionaries, templates, macros, forms
Registry Settings
```

The e-mail address identification in the Mail Object 66 includes addresses such as a Point-Of-Presence (“POP”), a Simple Mail Transfer Protocol (“SMTP”) and other e-mail related addresses.

The Applications object 68 includes configuration settings of applications installed on the source computing system 12. For example, the applications may include Microsoft Word, Excel, Power Point, etc., applications and related files, other applications in the Word Perfect Suite, by Corel and other applications and related files (e.g., audio, video, graphics, etc.) from the source computing system 12.

Exemplary configuration settings included in the Application object 68 are illustrated in Table 5. However, more, fewer or equivalent configuration settings can also be used in the Application object 68, and the present invention is not limited to the configuration settings illustrated in Table 5.

TABLE 5
Application Object 68

```
Application
    Word, Excel, Power Point, Word Perfect, etc.
Settings
    Dictionaries, style, formats, language, fonts, etc.
Files: DOC, RTF, XLS, PPT, WP, MPG, MDI, BMP,
JPG, WAV, etc.
Registry Settings
```

In one exemplary preferred embodiment of the present invention, the Application object 68 includes configuration settings for applications following design guidelines developed for Microsoft Windows operating system applications. However, other design guideline developed for applications for other operating systems, such as Linux, could also be used to determine which configuration settings are included in the Application object 68, and the present invention is not limited to an Application object 68 including configuration settings for just Microsoft Windows applications.

Exemplary Automatic Configuration Setting Translation

Returning to FIG. 3, at Step 48, multiple configuration settings are located on a source computing system using multiple transition rules from the Personality object 58 (FIG. 4). In one exemplary preferred embodiment of the present invention, the Extraction application 18 uses the Personality object 58 to locate configuration settings on the source computing system 12.

The locating Step 48 can also be used to locate configuration settings on more than one computer simultaneously (e.g., a desktop computer and a laptop computer). The User Interface application 20 is used to configure the Extraction application 18. The User Interface application 20 includes a list of “identity units” corresponding to configuration settings that will be extracted from the source computing system 12 and infused on the target computing system 26. The User Interface application 20 includes the ability to “drill-down” to multiple options and sub-options within an identity unit.

The User Interface application 20 configures the Extraction application 18 with the following options: 1) what configuration settings to extract; 2) where to store the results; 3) at what level will the extraction take place; 4) how the results are “tagged” for later retrieval; and 5) how verbose or silent the extraction process is. However, more, fewer or equivalent options could also be configured on Extraction application 18.

The “what to extract” option includes creating an Extraction plan. The Extraction plan identifies specific identity units that should be located and a list of options for each identity unit. The Extraction plan includes a full list of identity units to be located, an exclusion list and an inclusion list. The full list is a “vanilla” state that specifies all identity units known on the source computing system 12 that should be located and extracted. The Extraction plan may be modified by excluding one or more identity units from the full list. For example, if the full list included 250 identity units, an exclusion list could be used to exclude 50 identity units from the full list. If available, the Extraction application 18, uses the exclusion list instead of the full list to locate and extract configuration settings corresponding to the identity units from the source computing system 12 (e.g., at Steps 50 and 52 of Method 48).

The inclusion list allows a user to select any of the identity units from the full list. For example, if the full list included 250 identity units, a user may select only 30 identity units from the 250 available identity units. Thus, the only the 30 configuration settings from the inclusion list from the Extraction plan will marked as “active.” The remaining 230 possible configuration settings are marked as “in-active” and are not used. If available, the Extraction application 18, uses the inclusion list instead of the full list to locate and extract the configuration settings corresponding to the identity units. If no exclusion list or inclusion list is created, the Extraction application 18, by default uses the full list to locate and extract configuration settings on the source computing system 12.

The User Interface 20 is also used to configure the Preparation application 22. The Preparation application 22 is configured in a similar manner to that described for the Extraction application 18. However, the Preparation application 22 includes a “Transition plan” instead of an Extraction plan. The Transition plan includes a full list, as a default list, and allows creation of exclusion and inclusion lists as was discussed for the Extraction plan.

Returning again to FIG. 3, at Step 50, multiple configuration settings are extracted from multiple locations on the source computing system by the Extraction application 18 using the Personality object 60. In one exemplary preferred embodiment of the present invention, the Extraction application 18 uses objects from the Personality object 60 and the Extraction plan described to produce “work product” that is stored in a pre-determined transition format at Step 52. In one exemplary preferred embodiment of the present invention, the work product is stored on the source computing system 12. In another exemplary preferred embodiment of the present invention, the work product is stored on one or more intermediate computing systems in volatile or non-volatile storage.

In one preferred embodiment of the present invention, the pre-determined transition format used to store the configuration settings is a database format for relational databases. However, non-relational database formats could also be used. In one preferred embodiment of the present invention, the pre-determined transition format is a database format for System Query Language (“SQL”) databases. In another preferred embodiment of the present invention, the predetermined transfer format is a database format for a Microsoft Access databases. However, other pre-determined transition formats can also be used and the present invention is not limited to the database formats described.

In one exemplary preferred embodiment of the present invention, the Extraction application 18 stores the configuration settings in a pre-determined transition format in temporary volatile storage (e.g., in RAM). In another exemplary preferred embodiment of the present invention, the Extraction application 18 includes a Loader application that is used to transfer data from temporary storage to the database 16. In such an embodiment, the Extraction application 18 does not maintain a persistent connection with the database 16. The transfer of information from temporary storage to the database 16 is accomplished with the Loader application. In yet another exemplary preferred embodiment of the present invention, the Extraction application 18 maintains a persistent connection with the database 16 and is capable of writing configuration settings in the predetermined format directly into the database 16.

At Step 54, the multiple extracted configuration settings stored in the pre-determined transition format are manipulated. In a preferred embodiment of the present invention, the configuration settings are manipulated with the Preparation application 22 using the Transition plan described above. For example, the Extraction application 18 may extract 250 configuration settings from the source computer with an exemplary Extraction plan that included only a full list (i.e., no extraction list or inclusion list). An exemplary Transition plan may include only an inclusion list. The exemplary inclusion list may include only 30 of 250 possible configuration settings from the Extraction plan. Thus, the only the 30 configuration settings from the inclusion list from the Transition plan will marked as “active” in the predetermined transition format by the Preparation application 22. The remaining 230 possible configuration settings are marked as “in-active” by the Preparation application 22 and not used. Various combinations of full lists, exclusion lists, inclusion lists, from the Extraction plan and Transition plan can be used, and the present invention is not limited to this example.

The manipulation at Step 54 also includes transitioning one or more configuration settings from a format used on the source computing system to a format used on the target computing system. For example, a configuration setting for a computer monitor may be stored with the name config-monitor-old on the source computer system. However, on the target computer system, the same configuration setting may be stored with a name config-monitor-new. In addition, a configuration setting may be stored in a first directory-A on the source system, and in a second directory-B, on the target system. The preparation application 22 handles such transitions at step 54.

At Step 56, a transition package is created from the multiple manipulated configuration settings. In an exemplary preferred embodiment of the present invention, the Preparation application 22 creates a transition package. In one exemplary preferred embodiment of the present invention, the transition package includes a list of commands along with necessary source data for the manipulated configuration settings. The list of command may be used to provide an ordering for transitioning the configuration settings. However, other transition package formats could also be used and the present invention is not limited to the transition packages described. The transition package will be used by the Injection application 24 to transition the desired configuration settings from the source computing system 12 the target computing system 26.

In an exemplary preferred embodiment of the present invention, the transition package is stored in the database 16 by the Preparation application 22. In another exemplary preferred embodiment of the present invention, the transition package is also transferred directly to the Injection application 24. In yet another exemplary preferred embodiment of the present invention, the transition package is read from the database 16 by the Preparation application 22 and the Injection application included in at a later time.

Applying a Transition Package to a Target Computing System

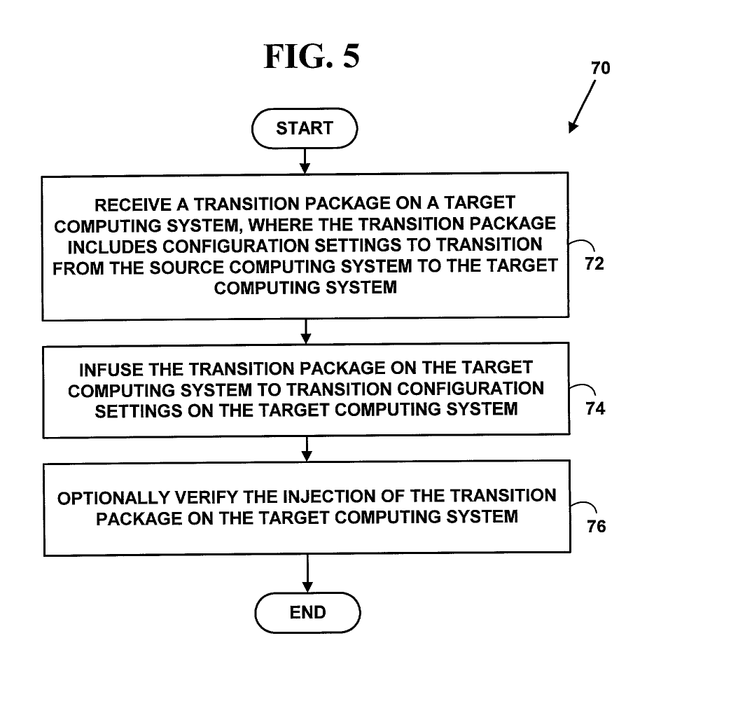

FIG. 5 is a flow diagram illustrating a Method 70 for automatically applying transition configuration settings. At Step 72, a transition package is received on a target computing system from a source computing system. At Step 74, the transition package is infused on the target computing system to automatically transition manipulated configuration settings from the source computing system to the target computing system. At Step 76, transition package is optionally verified on the target computing system to ensure that the transition package has been correctly applied to the target computing system.

In one exemplary preferred embodiment of the present invention, the transition package is sent from the Preparation application 22 on the source computing system 12 within an Injection application 24 to the target computing system 26. The Injection application 24 with the transition package can be sent to the target computing system 26 via on a floppy disk, zip-disk, or CD-ROM, or transferred using e-mail, TCP/IP, FTP, or with other network transfer mechanisms. At Step 72, the target computing system 26 receives the Injection application 24 with the transition package from the source computing system 12. As was described above, in one exemplary preferred embodiment of the present invention, the transition package includes a list of commands along with necessary source data for multiple manipulated configuration settings. At Step 74, an Injection application 24 “infuses” the target computing system 26 with manipulated configuration settings from the source computing system 12. The Injection application 24 reads and executes the list of commands from the transition package to transition configuration to the target computing system 26. The Injection application 24 is invoked by the operating system 34 on the target computing system. At Step 76, transition package is optionally verified on the target computing system 26 to ensure that the transition package has been correctly applied to the target computing system 26. In one exemplary preferred embodiment of the present invention, the Injection application 24 also verifies the injection of the transition configuration settings on the target computing system 26. In another exemplary preferred embodiment of the present invention, a separate Verification application verifies configuration settings infused by the Injection application 24.

Exemplary Automatic Transition of Configuration Settings

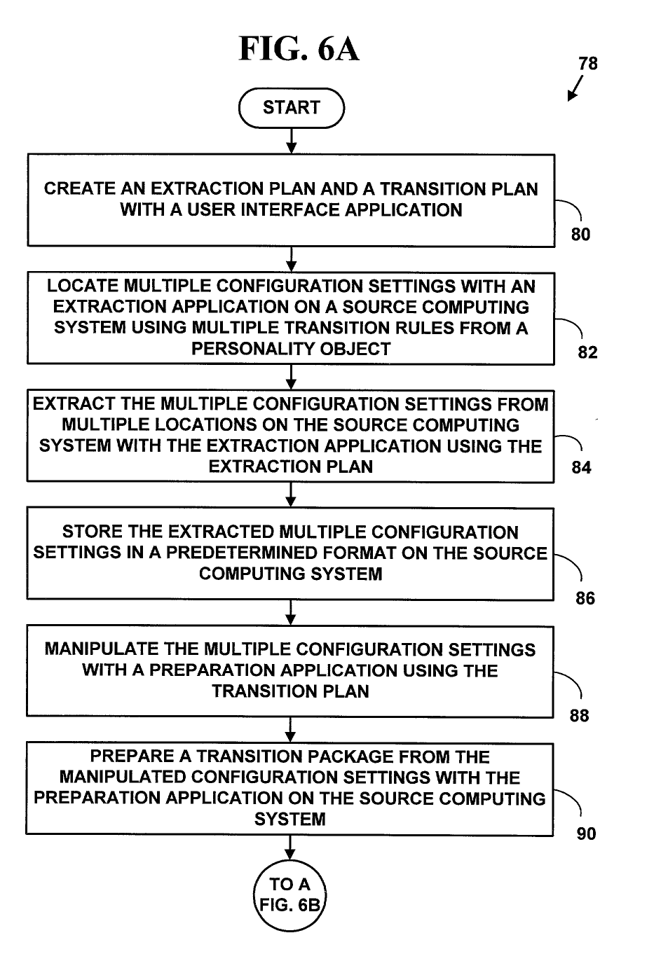

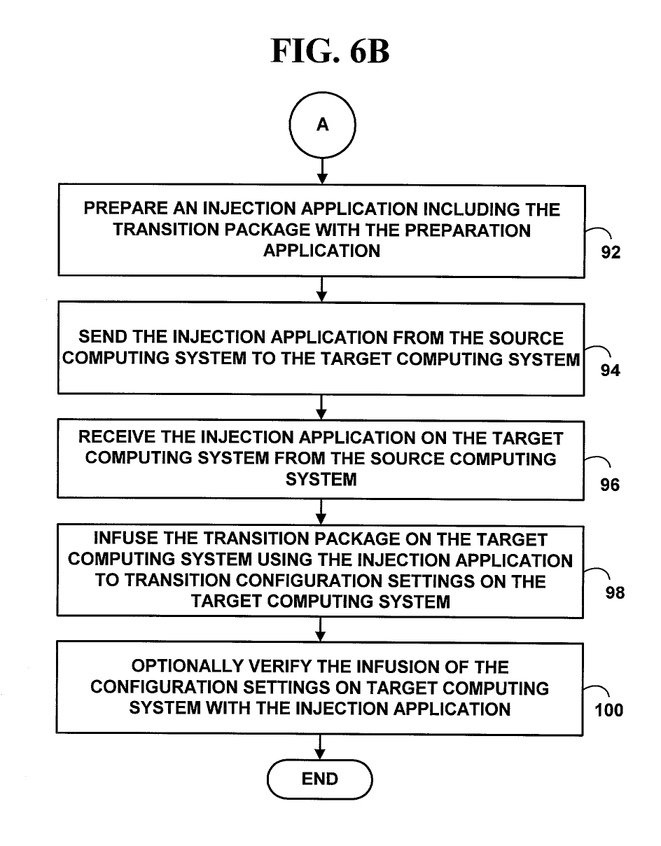

FIGS. 6A and 6B are flow diagram 78 illustrating one exemplary method for automatically transitioning configuration settings for one exemplary preferred embodiment of the present invention. However, the present invention is not limited to this exemplary embodiment and other embodiments could also be used. At Step 80 of FIG. 6A, an Extraction plan and a Transition plan are prepared with the User Interface application 20. At Step 82, multiple configuration settings are located on a source computing system 12 with an Extraction application 18 using a Personality object 58. At step 84, the multiple configuration settings are extracted from multiple locations on the source computing system 12 with the Extraction application 18 and the Extraction plan. At Step 86, the multiple extracted configuration settings are stored in a database format on the source computing system 12. At Step 88, the multiple extracted configuration settings are manipulated with a Preparation application 22 and the Transition plan. At Step 90, a transition package is prepared from the multiple manipulated configuration settings by the Preparation application 22. The transition package is used to transition configuration settings from the source computing system to the target computing system 26.

At Step 92 of FIG. 6B, an Injection application 24 including the transition package is prepared by the Preparation application 22. The Injection application 24 uses the transition package to transition configuration settings from the source computing system to the target computing system. At Step 94, the Injection application 24 including the transition package is sent from the source computing system 12 to the target computing system 26.

At Step 96, the Injection application including the transition package is received on the target computing system 26 from the source computing system 12. At Step 98, the transition package is infused with the Injection application 24 on the target computing system 26 to transition configuration settings from the source computing system 12 to the target computing system 26. At Step 100, configuration settings from the transition package are optionally verified with the Injection application 24 to ensure that the transition package has been correctly applied to the target computing system.

Data Flow for Exemplary Automatic Transition of Configuration Settings

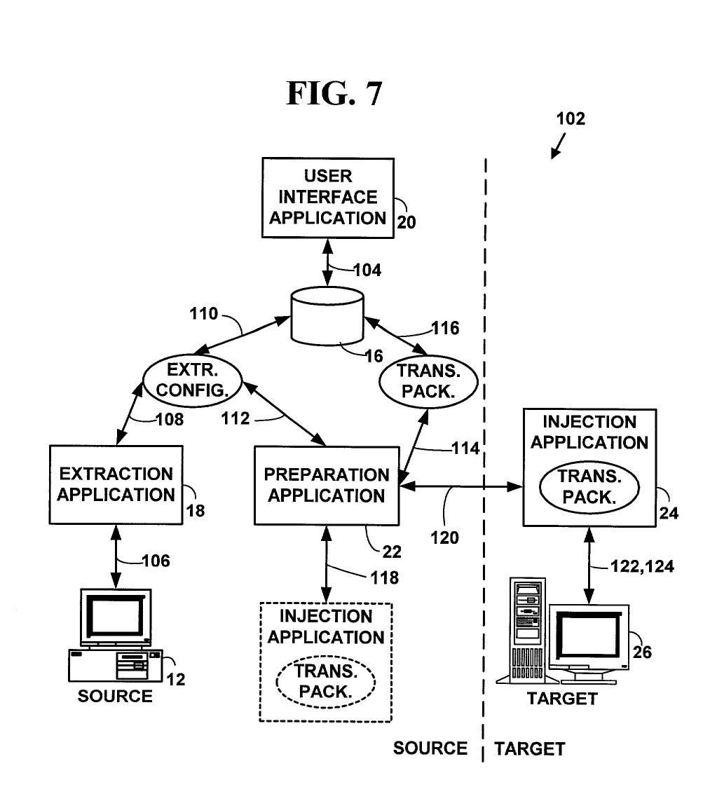

FIG. 7 is a block diagram illustrating a data flow 102 for the automatic configuration setting transition from FIGS. 6A and 6B. The User Interface application 20 is used to create 104 an Extraction plan and a Transition plan (e.g., Step 80 of FIG. 6A). The Extraction application 18 locates and extracts 106 multiple configuration settings from multiple locations on the source computing system using the Personality object 58 and the Extraction plan (e.g., Steps 82 and 84). The multiple extracted configuration settings are stored 108 in a predetermined transition format in temporary storage on the source computing system 12 (e.g., Step 86). The multiple extracted configuration settings may also be stored 110 in persistent storage in the database 16. The Preparation application 22 manipulates 112 the multiple extracted configuration settings stored in the pre-determined transition format using the Transition plan (e.g., Step 88). The Preparation application 22 creates 114 a transition package from the multiple manipulated configuration settings. The transition package includes the multiple manipulated configuration settings (e.g., Step 90).

As was discussed above, the transition package can be stored 116 in the database 16 by the Preparation application 22. The transition package can also be transferred directly to the Injection application 24. The transition package can also be read from the database 16 by the Preparation application 22 and sent to the Injection application 24 at a later time. The Preparation application 22 prepares 118 an Injection Application 24 including the transition package (e.g., Step 92, FIG. 6B). The Injection Application 24 is sent 120 from the source computing system 12 to the target computing system 26 (e.g., Step 94).

The target computing system 26 receives the injection application 24 with transition package from the source computing system 12 (e.g., Step 96). The Injection application 24 “infuses” 122 the target computing system 26 with manipulated configuration settings in the transition package from the source computing system 12 (e.g., Step 98). The Injection application 24 reads and executes the list of commands from the transition package to transition configuration to the target computing system 26. The transition package is optionally verified 124 on the target computing system 26 to ensure that the transition package has been correctly applied to the target computing system 26 (e.g., Step 100).

Exemplary Automatic Transition Products

In one exemplary preferred embodiment of the present invention, the Extraction application 18, the User Interface application 20, the Preparation application 22 and the Injection application 24 are Windows 32-bit (“Win32”) applications written in C++, Java and Visual Basic. However, the present invention is not limited to Win32 applications, and other types of applications can also be used. In addition, other programming languages could also be used to implement the transition applications. The transition Win32 applications support the exemplary transition illustrated in Table 6. However, the present invention is not limited to the transitions illustrated in Table 6, and other transitions could also be made between a source computing system and a target computing system.

TABLE 6

Windows 95 ver. X to Windows 95 ver. Y
Windows 95 to Windows 98
Windows 98 ver. X to Windows 98 ver. Y
Windows 98 to Windows ME
Windows 95 to Windows NT
Windows 98 to Windows NT
Windows ME to Windows 2000
Windows NT to Windows 2000
Windows NT ver. X to Window NT ver. Y
Windows XX to Windows YY
Windows XX ver. X to Windows YY ver. Y

In one exemplary preferred embodiment of the present invention, the present invention may also include the transition of configuration settings to a target computing system that are NOT present on a source computing system, but were calculated from other settings on the source computing system. Such an embodiment can be inclusive such that “old settings” as well as “new calculated settings” are injected. The translation process may also be exclusive such that a target computing system does not receive any “old settings” but only new settings “calculated” from the old settings on a source computing system. The translation process may also be used for extracting configuration settings from multiple source computing systems that are local or remote, and “conglomerating” them onto a single target computing system.

In another exemplary preferred embodiment of the present invention, configuration settings can be transitioned without any transition data ever being embodied into a persistent storage medium. In such an embodiment, extracted transition data is transmitted via a data stream over a network (e.g., the Internet or an intranet, etc.) and is consumed (i.e., processed and or injected) without ever being stored in a persistent storage medium.

In yet another exemplary preferred embodiment of the present invention, a target computing system can be infused with configurations settings that have not originated from a source computing system and have not been calculated from old configuration settings on the source computing system. In such an embodiment, a new target computing system is built and configuration settings are from a “newly developed” source that is not a source computing system (e.g., a proposed new operating system or proposed new computer hardware).

In yet another embodiment of the present invention, the transitioning process may also take settings from a single source computing system and “distribute” them to multiple target computing systems such that only a subset of the settings from the source computing system reside on any one target computing system. The subsets of transition data may overlap or be exclusive.

In yet another embodiment of the present invention, the transition process may take configuration settings from multiple source computing systems and inject them onto multiple target computing systems, but in a manner such that there is no correlation between the configuration settings from the source computing systems and target computing systems the configuration settings are injected onto. For example, three configuration settings from a first source computing system are transitioned to a first set target computing systems, while one configuration setting from a second source computing system is transitioned to a second set of target computing systems not including the first set of target computing systems. There can also be direct correlation of the configuration settings from the multiple source computing systems to the multiple target computing systems.

Rule Based File Transition

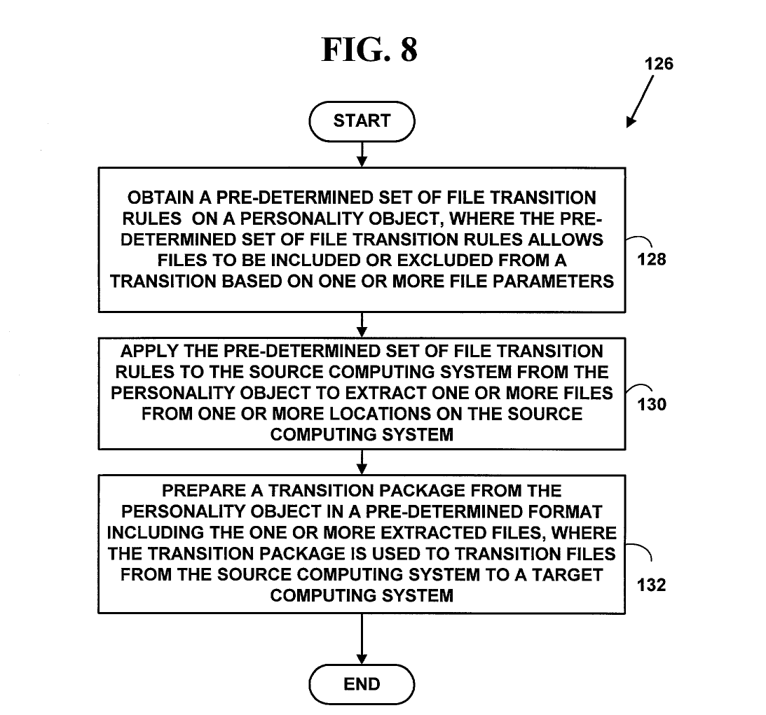

FIG. 8 is a flow diagram illustrating a Method 126 for automatically transitioning files from a source computing system to a target computing system. At Step 128, a pre-determined set of file transition rules are obtained on a Personality Object. The pre-determined set of file transition rules allows files to be included or excluded from a transition based on one or more file parameters. At Step 130, the pre-determined set of file transition rules are applied to the source computing system from the Personality Object to extract one or more files from one or more locations on the source computing system. At Step 132, a transition package is prepared from the Personality Object in a pre-determined format including the one or more extracted files. The transition package is used to transition files from the source computing system to a target computing system.

In one embodiment of the present invention, the pre-determined set of file transition rules are saved in persistent storage on the source computing system or in the transition package.

In one embodiment of the present invention, Method 126 further comprises transferring the transition package to the target computing system, infusing the transition package on the target computing system to transition files from the source computing system to the target computing system, and optionally verifying the infusion of the transition package to ensure that the extracted files have been correctly transitioned to the target computing system.

Method 126 is illustrated with an exemplary embodiment of the present invention. However, the present invention is not limited to this exemplary embodiment and other or equivalent embodiments can also be used.

In such an exemplary embodiment at Step 128, a pre-determined set of file transition rules are obtained on a Personality Object 58 (FIG. 4) from an Extraction plan. The pre-determined set of file transition rules allows files to be included or excluded from a transition based on one or more file parameters. The pre-determined set of file transition rules are one type of the multiple transitions rules used by the Personality Object 58 as was described above. In one embodiment of the present invention, the file transition rules are stored in the Applications Object 68. However, the present invention is not limited to such an embodiment, and the file transition rules can also be stored in other locations inside and outside of the Personality Object 58.

In one embodiment of the present invention, the Extraction application 18 uses the Personality Object 58 to obtain the pre-determined set of file transition rules from the Extraction plan. However, the present invention is not limited to such an embodiment, and other applications (e.g., the User Interface Application 20, etc.) can also use the Personality Object 58 to obtain the pre-determine set of file transition rules.

In one embodiment of the present invention, the predetermined set of file transition rules are obtained on the Personality Object 58 through an object-oriented ActiveX control interface called “IFileControl.” However, the present invention is not limited to such an embodiment and the set of file transition rules can also be obtained using other, or equivalent object-oriented and non-object oriented interfaces.

In such an embodiment, the ActiveX interface IfileControl includes an object-oriented method called “GetRule( )” in a “File Rules Control.” The File Rules Control is a component of an ActiveX based COM object. An exemplary GetRule( ) object-oriented method is illustrated in Table 7. However, other, or equivalent object-oriented methods could also be used to obtain a pre-detennined set of file transition rules and the present invention is not limited to the object-oriented method illustrated in Table 7.

TABLE 7
Copyright © 1999 by Trauxition Corporation. All rights reserved.

| | |
|---|---|
| HRESULT GetRule | ( |
| | [out] VARIANT *varSrcPath, |
| | [out] VARIANT *varPattern, |
| | [out] VARIANT *varInc, |
| | [out] VARIANT *varIncSub, |
| | [out] VARIANT *varDateLimit, |
| | [out] VARIANT *varDate, |
| | [out] VARIANT *varSizeLimit |
| | [out] VARIANT *varSize, |
| | [out] VARIANT *varRemapDest, |
| | [out] VARIANT *varDestPath, |
| | [out] VARIANT *varPrsSub |
| | ) |

| | |
|---|---|
| Parameter Details: | |
| varSrcPath | Used to store a Source Path string for |
| | the rule. (This is an OUT parameter) |
| varPattern | Used to store a pattern string (e.g., |
| | the wildcard characters for different |
| | file types.) (This is a OUT parameter) |
| varInc | This variable holds a Boolean value |
| | whether a specified file is to be |
| | included or excluded. (This is an |
| | OUT parameter) |
| varIncSub | This variable holds the Boolean value |
| | for an inclusion of sub directories for |
| | a given directory. (This is an OUT |
| | parameter) |
| varDateLimit | This variable holds the type of |
| | comparison to be performed for a |
| | given file and a date provided by the |
| | user. (This is a OUT parameter) |
| varDate | This variable holds a date (if |
| | specified by a user) that needs to be |
| | compared with the date of a file |
| | depending upon the type of |
| | comparison specified by the user. |
| | (This is an OUT parameter) |
| varSizeLimit | This variable holds a type of |
| | comparison to be performed for a |
| | given file and a size provided by the |
| | user. (This is an OUT parameter) |
| varSize | This variable holds a size (if specified |
| | by a user) that needs to be compared |
| | with the size of a file depending upon |
| | a type of comparison specified by a |
| | user. (This is an OUT parameter) |
| varDestPath | This is used to store the destination |
| | path string if a user needs to Remap |
| | the destination for selected files. |
| | (This is an OUT parameter) |
| varPrsSubDir | This variable holds a Boolean value |
| | to indicate whether the sub-directory |
| | structure is to be preserved for a |
| | given directory or not. (This is an |
| | OUT parameter) |

This object-oriented method returns one rule at a time to a calling control.

In one embodiment of the present invention, file and directory inclusion or exclusion is expressed as a set of file transition rules. File transitions rules comprise one or more rule properties. The predetermined set of file transition rules allows files to be included or excluded from a transition based on one or more file parameters. The pre-determined set of file transition rules include a rule precedence.

Exemplary file transition rule properties are illustrated in Table 8. However, more, fewer or equivalent rule properties can also be used and the present invention is not limited to the file transition rules properties illustrated in Table 8.

TABLE 8

| File Transition | |
|---|---|
| Rule Property | Description |
| Source Path | The source path property defines an extraction |
| | file set for a rule. It can be a path pointing to a |
| | directory, a set of files, or a single file. The wild |
| | card characters ‘*’ and ‘7’ are supported. |
| Include Subdirectories | If the source path property points to a directory |
| | or set of files, the include subdirectories |
| | property can be either set or cleared. If set, the |
| | source path will be seen as including all |
| | subdirectories under the specified directory. If |
| | cleared, the source path will be seen as |
| | including only the explicit directory contained in |
| | the path, without including any of its |
| | subdirectories. |
| Include | The include property and exclude property act |
| | like a radio button set. One and only one of |
| | these two properties is set for each rule. If the |
| | include property is set, it signifies that the file |
| | set defined by the source path is to be included |
| | in the overall migrated file set at extraction |
| | time. |
| Exclude | If the exclude property is set, it signifies that |
| | the file set defined by the source path is to be |
| | explicitly excluded from transition at extraction |
| | time. |
| Date | The Date property is an optional property |
| | available for each rule. Using this property, the |
| | user can specify that the file set is limited by |
| | the “last date modified”. Specifically, the user |
| | can specify files since a certain date, which will |
| | mean files modified on or after the specified |
| | date, or the user can specify files before a |
| | certain date, which will mean files modified |
| | before the specified date. |
| File Size | The File Size property is an optional property |
| | available for each rule. The user can use this |
| | property to limit the file set specified by file |
| | size. Specifically, he can specify all files up to |
| | and including a specified file size, or all files the |
| | specified file size or larger. |
| Destination Path | The destination path property is an optional |
| | property for a file rule. Any path entered here |
| | will become the destination path, on the |
| | injection computer, of the file set specified. |
| | Using this property, a user may build a rule that |
| | will result in file name collisions on the injection |
| | computer. This can happen when a Source |
| | Path specifies multiple folders which are |
| | remapped to a single folder. When files with |
| | duplicate names are injected in this case, the |
| | first file injected will retain the original file |
| | name. Subsequent injected files with the same |
| | name will have a suffix appended to the file |
| | name in the form 1, 2, etc. |
| Preserve | If the file set specified by the source path is an |
| Subdirectories | include set, and if the include subdirectories |
| | property is also set, then the preserve |
| | subdirectories property comes into play. If it is |
| | set, then the subdirectory structure of the file |
| | set at extraction time will be preserved on the |
| | injection side. |
| Order of Precedence | The set of file transition rules have an order of |
| | precedence. By combining rules using that |
| | precedence, complex data sets can be defined |
| | for either inclusion or exclusion. |

Both the source path and destination path rule properties support the inclusion of predefined system variables. In one embodiment of the present invention, these variables represent dynamic values that are resolved at runtime. In another embodiment of the present invention, these variables represent static values. The variables include windows shell folders and appropriate system values. Variables are specified by using the form %VARIABLE%, where VARIABLE is the name of the specific system variable being used. Table 9 illustrates exemplary system variables. However, more, fewer or equivalent variables can also be used and the present invention is not limited to the variable illustrated in Table 9.

TABLE 9

| System Variable | Description |
|---|---|
| %MYDOCUMENTS% | A default office document storage directory |
| %WINDOWS% | A window's directory |
| %SYSTEM% | A windows system directory |
| %USERNAME% | A user name of the currently logged in user |
| %DOMAIN% | A current network domain of the logged in user |
| %MYCOMPUTER% | A current computer, including all local fixed |
| | disk drives |
| %DESKTOP% | A computer desktop |

In one embodiment of the present invention, the file transition rules that are operable during an extraction are stored as part of the transition package. In such an embodiment, changes made to the rules after an extraction is made will not affect a subsequent injection. In another embodiment of the present invention, the file transition rules are not stored in the transition package. In such an embodiment, changes made to the file transition rules after an extraction is made can affect a subsequent injection.

Returning to FIG. 8 at Step 130, the predetermined set of file transition rules are applied to the source computing system from the Personality Object 58 to extract at the File Layer 44 (FIG. 2) one or more files from one or more locations on the source computing system. Files are one type of “identity units” that are extracted from the source computing system 12 using the Extraction plan. Identity units were explained above.

Tables 10-16 illustrate the application of five different exemplary file transition rules. However, the present invention is not limited to such file transition rules, and more, fewer or equivalent file transition rules can also be used.

TABLE 10

| | | | | | | | |
|---|---|---|---|---|---|---|---|
| | | | Inc | | | Destination | Prs |
| Source Path | Date | File Size | Sub | Inc | Exc | Path | Sub |

| | | |
|---|---|---|
| % DESKTOP %/*.exe | YES | X |

The exemplary rule in Table 10 specifies that all executable files (“.exe”) on the desktop, including all those found in desktop subdirectories, will be absolutely excluded from a transition package.

TABLE 11

| | | | | | | | |
|---|---|---|---|---|---|---|---|
| | | | Inc | | | Destination | Prs |
| Source Path | Date | File Size | Sub | Inc | Exc | Path | Sub |

| | | |
|---|---|---|
| C:/TimeCardData/*.tmc | NO | X |

The exemplary rule in Table 11 specifies that all time card file (“.tmc”) files, found in the directory “c:\TimeCardData” will be absolutely included in the transition package. Subdirectories of “c:\TimeCardData” will not be included.

TABLE 12

| | | File | Inc | | | Destination | Prs |
|---|---|---|---|---|---|---|---|
| Source Path | Date | Size | Sub | Inc | Exc | Path | Sub |
| % MYCOMPUTER %/*.doc | Since | | YES | X | | % MYDOCUMENTS % | NO |
| | 05/15/00 | | | | | | |

The exemplary rule in Table 12 specifies that all Microsoft Word document (“.doc”) files, modified since May 15, 2000 (inclusive), will be included in the transition package. Additionally, using the destination path and preserve subdirectories (“PrsSub”) properties, the user has specified that all .doc files should be injected into the %MYDOCUMENTS% folder on the target machine without preserving any associated subdirectory structure. This, in effect, flattens and consolidates all .doc storage to the Windows My Documents folder.

TABLE 13

| | | | | | | | |
|---|---|---|---|---|---|---|---|
| | | | | | | Destin- | |
| | | File | Inc | | | ation | Prs |
| Source Path | Date | Size | Sub | Inc | Exc | Path | Sub |

| | | |
|---|---|---|
| % WINDOWS %/*.* | YES | X |

The exemplary rule in Table 13 excludes all files in the Windows directory, including all its subdirectories, from the transition package.

TABLE 14

| | | File | Inc | | | Destination | Prs |
|---|---|---|---|---|---|---|---|
| Source Path | Date | Size | Sub | Inc | Exc | Path | Sub |
| % WINDOWS %/ | | <1000 k | YES | X | | % MYDOCUMENTS %/ | YES |
| MyPictures/*.bmp | | | | | | MyPictures | |

The exemplary rule in Table 14 specifies that all bitmap (“.bmp”) files found in %WINDOWS%/MyPictures, that have a file size of 1 meg or less be included in the transition package. Additionally, the destination for the files is remapped to the %MYDOCUMENTS%/MyPictures directory, preserving the original subdirectory structure.

Rule precedence is determined by a position of a rule in a rules list. In one embodiment of the present invention, a highest priority or “top rule” in a rules list is applied first, then the next lower rule, and so on. In another embodiment of the present invention, the “bottom rule” in a rules list is applied first, then a rule preceding the bottom rule is applied next, and so on. However, the present invention is not limited to such embodiments and other or equivalent types of rule precedence can also be used. Taking the rules in Tables 13 and 14 together in a vertical top-down rules list illustrated by Table 15, the operation of rule precedence is illustrated.

TABLE 15

| | | File | Inc | | | | Prs |
|---|---|---|---|---|---|---|---|
| Source Path | Date | Size | Sub | Inc | Exc | Destination Path | Sub |
| % WINDOWS %/*.* | | | YES | | X | | |
| % WINDOWS %/ | | <1000 k | YES | X | | % MYDOCUMENTS %/ | YES |
| MyPictures/*.bmp | | | | | | MyPictures | |

The first rule in Table 15 excludes all files from the windows directory and all its subdirectories. The next rule includes all bitmap files (of a certain size) in the directory %WINDOWS%\MyPictures. Working together, these two rules exclude all files in the %WINDOWS% directory except for the bitmap files specified in the second rule, which are explicitly included.

The operation of precedence as a result of improper rule ordering is illustrated in Table 16. In Table 16, the rules from Table 15 are reversed, so the last exclude rule effectively negates the top or first include rule.

TABLE 16

| | | File | Inc | | | | Prs |
|---|---|---|---|---|---|---|---|
| Source Path | Date | Size | Sub | Inc | Exc | Destination Path | Sub |
| % WINDOWS %\ | | <1000 k | YES | X | | % MYDOCUMENTS %\ | YES |
| MyPictures/*.bmp | | | | | | MyPictures | |
| % WINDOWS %\*.* | | | YES | | X | | |

Table 17 illustrates another exemplary object-oriented method in the ActiveX interface IfileControl from the File Rules Control called “GetSelectedFilesList( ).” This object-oriented method returns an array of files selected by user for inclusion in the transition package. This method returns the file names in a data structure called “safe array”, which is compatible with a C++/Java/VB environment and is also compatible with a VB script or JAVA script environment for use on the Internet with web browsers. However, the present invention is not limited to this embodiment and other or equivalent object-oriented methods can also be used.

TABLE 17
Copyright © 1999 by Tranxition Corporation. All rights reserved.

| | |
|---|---|
| HRESULT GetSelectedFileList | ( |
| | [in] VARIANT varRemapDest, |
| | [out, retval] VARIANT *pSA |
| | ) |

| | |
|---|---|
| Parameter Details: | |
| [in] VARIANT varRemapDest | Indicates whether to apply the |
| | latest rules to a file list or not. |
| [out, retval] VARIANT *pSA | The safe array (“SA”) |
| | contains the selected files. |
| | This is an out parameter. |

Returning to FIG. 8 at Step 132, a transition package is prepared from the Personality Object 58 in a pre-determined format including the one or more extracted files. The transition package is used to transition files from the source computing system 12 to a target computing system 26. The transition package with extracted files obtained with Method 126 is one type of “work product” described above (e.g., stored at Step 52 of Method 48).

In one embodiment of the present invention and as was described above, the transition package is stored in a predetermined database format for relational databases. However, non-relational database formats and other formats can also be used and the present invention is not limited to the database formats described.

In one embodiment of the present invention, Step 128 (FIG. 8) is used as an additional locating step at Step 48 (FIG. 3), Step 130 is used as an additional extracting step at Step 50 (FIG. 3), and Step 132 is used as an additional preparation step at Step 56 (FIG. 3). However, Method 126 can also be used as a stand-alone method to transition extracted files from a source computing system 12 to a target computing system 16 with the Personality Object 58.

Method 126 and the pre-determined file transition rules are used to create a transition product with file inclusion and exclusion sets that are operative across many different transitions, spanning many different source computing systems (i.e., a mass transition). The actual structure of file systems on the source computer system 12 is irrelevant since rules are used to make decisions about files for inclusion or exclusion regardless of their actual locations. A transition product created with predetermined file translation rules can be used to simultaneously transition multiple different files across multiple different target computing systems. However, a transition product based on file transition rules can also be used to make it easier to transition files from a single source computing system without considering a file system layout on the source computing system.

It is also desirable to provide the ability to transition individual files based on an actual “live” file system or directory hierarchy on the source computer system 12. The individual files may then be transition based on a hierarchical selection. A “live” file system is an actual file system layout on a source computing system at a “snapshot” in time when a file transition is requested and typically includes one or more transient files.

Hierarchical Based File Transition

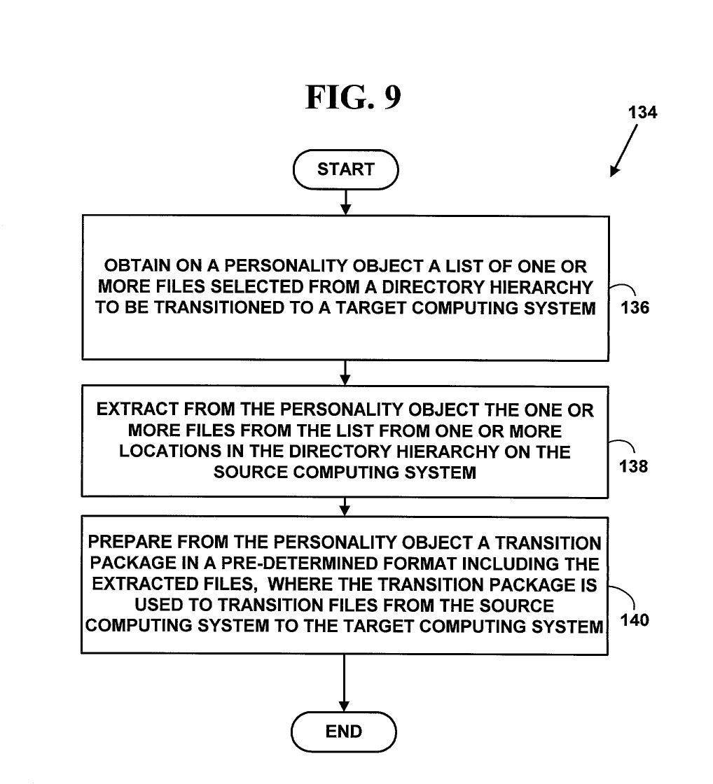

FIG. 9 is a flow diagram illustrating a Method 134 for automatically transitioning files from a source computing system to a target computing system using a hierarchy. At Step 136, a list of one or more files selected from a directory hierarchy to be transitioned to the target computing system is obtained on a Personality Object. At Step 138, the one or more files from the list are extracted from one or more locations in the directory hierarchy on the source computing system using the Personality Object. At Step 140, a transition package in a pre-determined format including one or more extracted files is prepared with the Personality Object. The transition package is used to transition files from the source computing system to the target computing system.

In one embodiment of the present invention, Method 134 further comprises saving a list of extracted files in persistent storage on the source computing system or in the transition package. In another embodiment of the present invention, Method 134 further comprises transferring the transition package to the target computing system, infusing the transition package on the target computing system to transition files from the source computing system to the target computing system, and optionally verifying the infusion of the transition package to ensure that the extracted files have been correctly transitioned to the target computing system.

Method 134 is illustrated with an exemplary embodiment of the present invention. However, the present invention is not limited to this embodiment and other equivalent embodiments can also be used.

In such an exemplary embodiment at Step 136 a list of one or more files selected from a directory hierarchy to be transitioned to the target computing system 26 is obtained on a Personality Object 58.

As is known in the art, a directory hierarchy is way of organizing and grouping files. Depending on how an operating system supports a directory hierarchy, filenames in a directory can typically be viewed and ordered in various ways. For example, with text alphabetically, by date, by size, as icons in a graphical user interface, etc. A directory is supported in an operating system by tables of data, stored in non-volatile storage, that indicates file characteristics and an actual physical location of each file in a directory hierarchy. In windowed operating systems, such as Microsoft Windows varieties and others, a directory is also called a “folder.” In a preferred embodiment of the present invention, a directory and a folder are used interchangeably.

The list of selected files enable file inclusion (selection) and exclusion in a hierarchical manner. That is, if a directory, folder or disk drive in a directory hierarchy is selected for inclusion, then all directories, folders and files underneath the selected directory, folder or disk drive can also be selected for inclusion. The same holds true for files to be deselected: If a directory, folder or disk drive is deselected, all directories, folders and files underneath it can also be deselected.

The list of selected files can also include files selectable for inclusion/exclusion by specifying a file type (extension) directory, folder or disk drive in the directory hierarchy. A file type is selectable at a directory, folder or a disk drive level. For example, if a file type such as a Microsoft Word document (“DOC”), in Windows operating system folder MyFolder, is selected and added to the list, then all files with type DOC will be selected if they are in or underneath MyFolder. This includes DOC files in folders that are underneath MyFolder. Other DOC files which may be in another part of the directory hierarchy are not affected and would be added to the list of files separately.

Returning to FIG. 9 at Step 138, the one or more files from the list are extracted at the file layer 44 (FIG. 2) from one or more locations in the directory hierarchy on the source computing system 12 using the Personality Object 58. In one embodiment of the present invention, Step 138 is implemented using a “File Tree Control” that exposes the entire eligible file system of source computer system 12 being extracted.

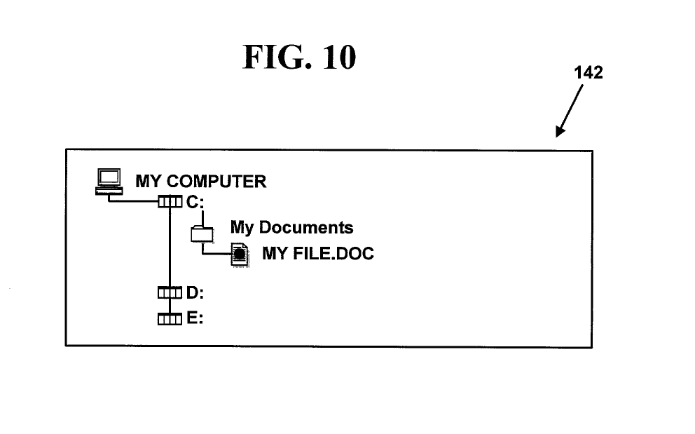

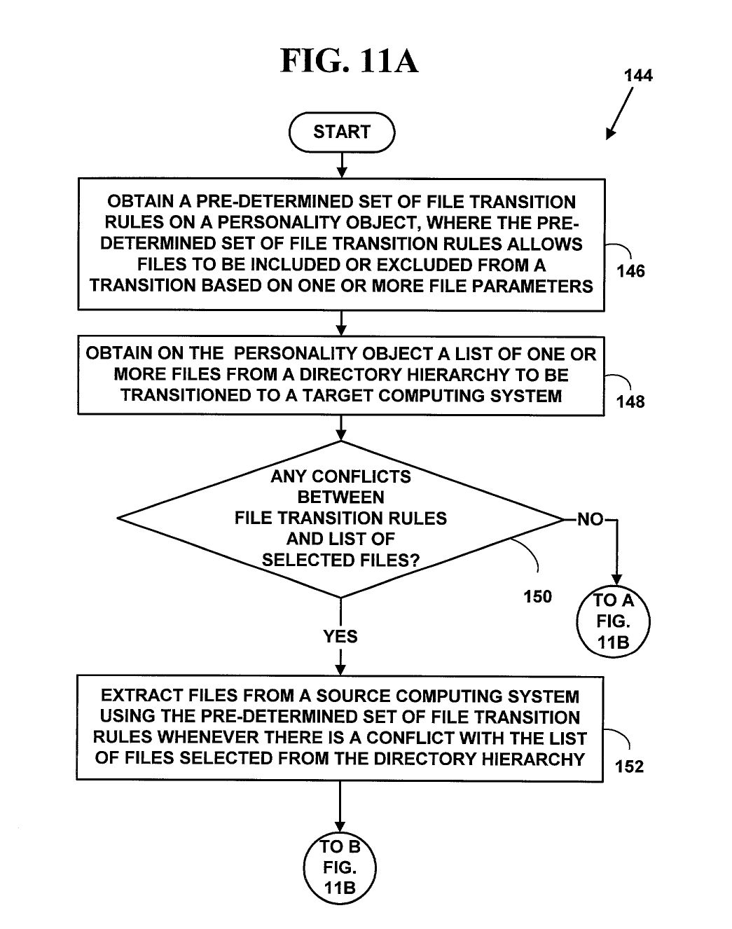

FIG. 10 is a block diagram 142 visually illustrating an exemplary exposure of an exemplary eligible file system of the source computer system 12 being extracted. FIG. 10 illustrates three disk drives (C:, D: and E:), one folder or directory (My Documents) and one file (My File.doc).

In such an embodiment, the ActiveX control interface IfileControl described above includes both the Files Rules Control and the File Tree Control components. The File Tree Control is also a component of the ActiveX based COM control IfileControl.

In one embodiment of the present invention, Step 136 is used as an additional locating step at Step 48 (FIG. 3), Step 138 is used as an additional extracting step at Step 50 (FIG. 3), and Step 140 is used as an additional preparation step at Step 56 (FIG. 3). In another embodiment of the preset invention, Step 136 is used as an additional obtaining step at Step 128 (FIG. 8), Step 138 is used as an additional extracting step at Step 130 (FIG. 8), and Step 140 is used as an additional preparation step at Step 132.

However, Method 134 can also be used as a stand-alone method to transition extracted files from a source computing system 12 to a target computing system using a list of files from a directory hierarchy. However, Method 134 can also be used as a stand-alone method to transition extracted files with selected from a directory hierarchy from a source computing system 12 to a target computing system 16 in combination with the file transition rules described above.

Returning to FIG. 9, at Step 140, a transition package in a pre-determined format including the plurality of extracted files is prepared with the Personality Object 58. The transition package is used to transition files from the source computing system 12 to the target computing system 26. In one embodiment of the present invention and as was described above, the transition package is stored in a pre-determined database format for relational databases. However, non-relational database formats could also be used. However, other formats can also be used and the present invention is not limited to the database formats described.

Method 134 and the a list of one or more files selected from a directory hierarchy to be transitioned are used to create a transition product with file inclusion and exclusion sets that are operative across one transition, spanning one source computing system 12 (i.e., a single transition). The actual structure of a file system on the source computer system 12 is relevant since decisions about files for inclusion or exclusion depend on their actual locations in an actual live directory structure.

Combination Rule/Hierarchy File Transition

FIGS. 11A and 11B are a flow diagram illustrating a Method 144 for automatically transitioning files from a source computing system to a target computing system using a combination of a pre-determined set of file transition rules and a list of files selected from a directory hierarchy. In FIG. 11A at Step 146, a pre-determined set of file transition rules is obtained on a Personality Object. The pre-determined set of file transition rules allows files to be included or excluded from a transition based on one or more file parameters. At Step 148, a list of files selected from a directory hierarchy on the source computing system to be transitioned to the target computing system is obtained on the Personality Object. At Step 150, a test is conducted from the Personality Object to determine whether any files to be extracted using the predetermined set of file transition rules conflict with any files from the list of plurality of files selected from the directory hierarchy. If there are any conflicts, at Step 152 files are extracted from the source computing system using the pre-determined set of file transition rules whenever there is a conflict with the list of files selected from the directory hierarchy. In FIG. 11B, if there are not any conflicts, at Step 154 files are extracted from the source computing system using either the predetermined set of file transition rules or the list of files selected from the directory hierarchy. At Step 156, a transition package in a pre-determined format including the plurality of extracted files is prepared on the Personality Object. The transition package is used to transition files from the source computing system to the target computing system.

In one embodiment of the present invention, Method 144 further comprises transferring the transition package to the target computing system, infusing the transition package on the target computing system to transition files from the source computing system to the target computing system, and optionally verifying the infusion of the transition package to ensure that the extracted files have been correctly transitioned to the target computing system.

Method 144 is illustrated with an exemplary embodiment of the present invention. However, the present invention is not limited to this embodiment and other equivalent embodiments can also be used.

In such an exemplary embodiment in FIG. 1A at Step 146, a predetermined set of file transition rules is obtained on a Personality Object 58 (e.g., Tables 8-16). At Step 148, a list of files selected from a directory hierarchy on the source computing system 12 to be transitioned to the target computing system 26 is obtained on the Personality Object 58. At Step 150, a test is conducted from the Personality Object 58 to determine whether any files to be extracted using the pre-determined set of file transition rules conflict with any files from the list of plurality of files selected from the directory hierarchy.

In one embodiment of the present invention, the test is conducted using the File Rules Control and the File Tree Control described above. The test determines if there are any conflicts between the files to be included/excluded by the pre-determined file transition rules and the files in the list of files selected from the directory hierarchy. However, the present invention is not limited to such an embodiment and other components can be used to make the determination at Step 150.

The File Tree Control is designed to work together with the File Rules Control described above. The File Tree Control is hierarchy based and is typically, but not limited to, a single-session transition mechanism, and is driven by an actual live file system(s) at the time of extraction. The File Rules Control is rule based, and is typically, but not limited to, a mass transition mechanism independent of the actual live file system. However, the File Rules Control can also be used for a single-session transition, with or without the File Tree Control. The rules established by the File Rules Control are enforced on usage of the File Tree Control and preempt processing of files selected from a directory hierarchy.

If there are any conflicts, at Step 152 files are extracted at the file layer 44 (FIG. 2) from the source computing system 12 using the predetermined set of file transition rules whenever there is a conflict with the list of files selected from the directory hierarchy. For example, if a file or set of files is excluded from transition by a file transition rule using the File Rules Control then those files will not be selectable for inclusion in the list of files selected from the directory hierarchy using the File Tree Control. In a similar manner, if files are included in a transition by a file transition rule, they will not be selectable for exclusion from the directory hierarchy using the File Tree Control.

In FIG. 11B, if there are not any conflicts, at Step 154 files are extracted at the file layer 44 (FIG. 2) from the source computing system 12 using either the pre-determined set of file transition rules or the list of files selected from the directory hierarchy.

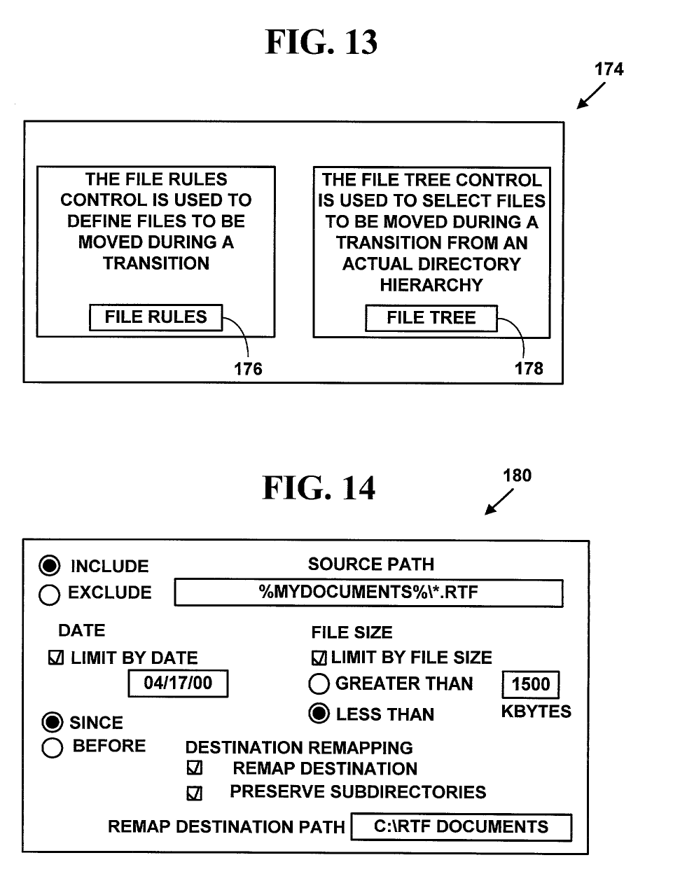

In one embodiment of the present invention, Steps 150, 152 and 154 are practiced via the User Interface application 20 using the Personality Object 58. In such an embodiment, any conflicts are overcome as the files are being selected. The User Interface application 20 manipulates graphical displays (e.g., FIGS. 13-15) to prevent or resolve dynamically conflicts as files are being selected. Thus, conflicts are overcome before any files are actually extracted.

In another embodiment of the present invention, Steps 150, 152 and 154 are practiced via the Extraction application 18 using the Personality Object 58. In such an embodiment, any conflicts are overcome dynamically during run-time as files are being extracted. Thus, conflicts are instead overcome as files are actually extracted. The User Interface application 20 does not prevent conflicts from being created as files are being selected.

However, the present invention is not limited to these two exemplary embodiments. Other or equivalent methods can also be used to resolve conflicts.

At Step 156, a transition package in a pre-determined format including the plurality of extracted files is prepared on the Personality Object 58. The transition package is used to transition files from the source computing system 12 to the target computing system 26. In one embodiment of the present invention and as was described above, the transition package is stored in a pre-determined database format for relational databases. However, non-relational database formats could also be used. However, other formats can also be used and the present invention is not limited to the database formats described.

Selecting File Transition Rules or Files from a Directory Hierarchy

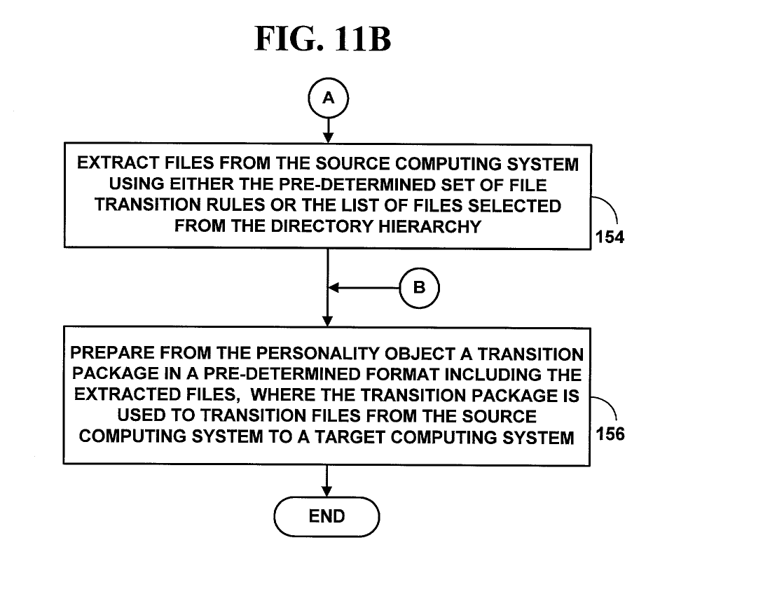

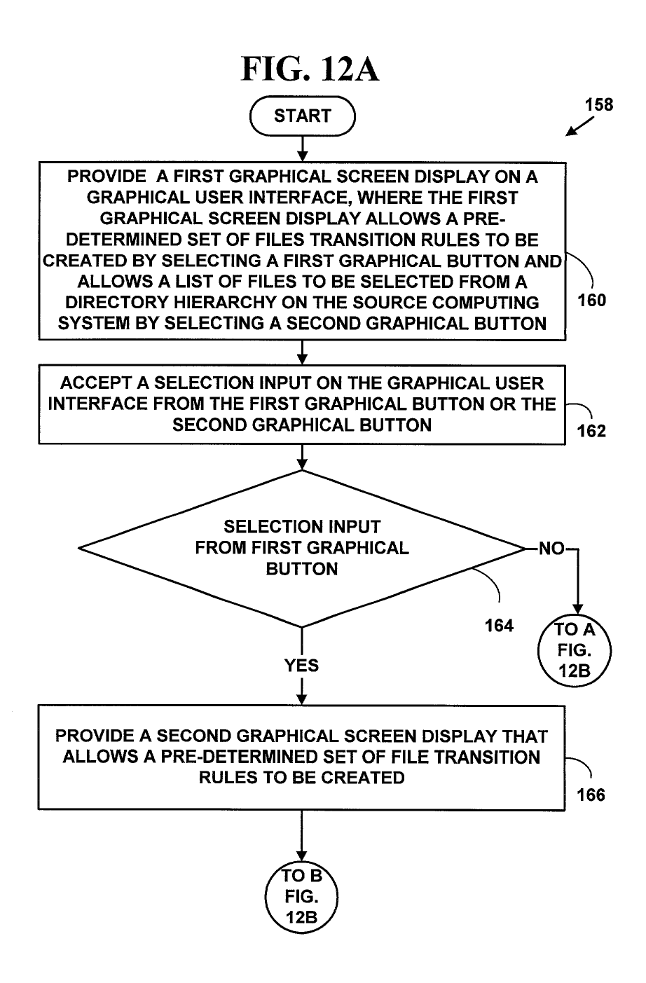

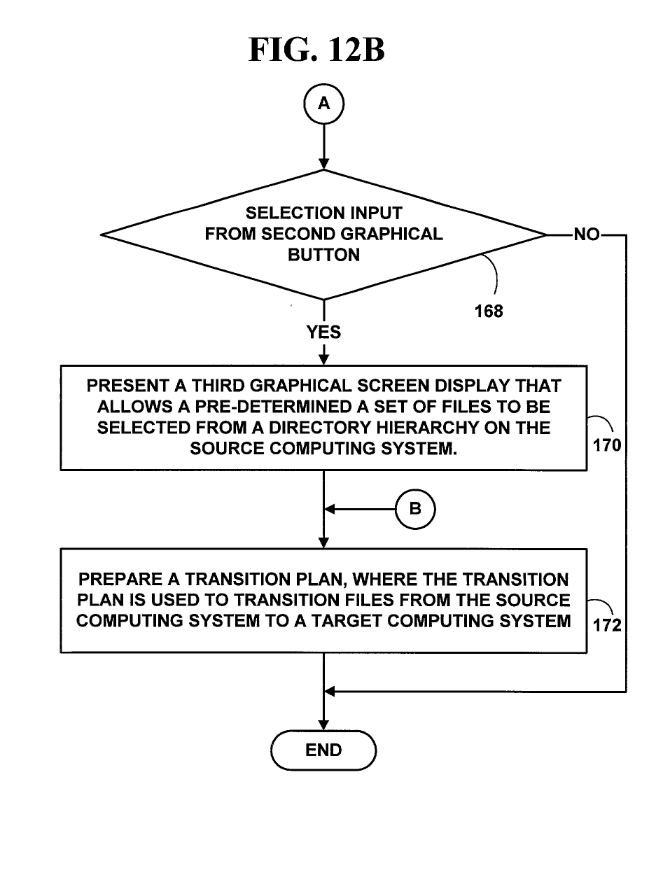

FIGS. 12A and 12B are a flow diagram illustrating a Method 158 for selecting file transition rules or a list of files from a directory hierarchy for transition. In FIG. 12A at Step 160, a first graphical screen display on a graphical user interface is provided. The first graphical screen display allows a predetermined set of files transition rules to be created by selecting a first graphical button and allows a list of files to be selected from a directory hierarchy on the source computing system by selecting a second graphical button. At Step 162, a selection input is received on the user interface application from the first graphical button or the second graphical button. At Step 164, a test is conducted to determine if the selection input is for the first graphical button. If the selection input is from the first graphical button, at Step 166, a second graphical screen display is provided that allows a pre-determined set of file transition rules to be created. In FIG. 12B at Step 168, a test is conducted to determine if the selection input is for the second graphical button. If the selection input is from the second graphical button, at Step 170, a third graphical screen display that allows a predetermined a set of files to be selected from a directory hierarchy on the source computing system. At Step 172, a transition plan is prepared based on the accepted selected input. The transition plan is used to transition files from a source computing system to a target computing system (e.g., a file transition with Methods 126, 134, 144).

Method 158 is illustrated with an exemplary embodiment of the present invention. However, the present invention is not limited to this embodiment and other equivalent embodiments can also be used. In FIG. 12A at Step 160, a first graphical screen display 174 on a windowed graphical user interface is provided with the User Interface application 20.

FIG. 13 is a block diagram illustrating a graphical screen display 174 for transitioning files. The graphical screen display 174 allows a pre-determined set of files transition rules to be created by selecting a first graphical button 176 and allows a list of files to be selected from a directory hierarchy on the source computing system by selecting a second graphical button 178.

Returning to FIG. 12A at Step 162, a selection input such as a mouse click, keyboard entry, etc. is received on the User Interface application 20 from the first graphical button 176 or the second graphical button 178. At Step 164, a test is conducted to determine if the selection input is for the first graphical button 178. If the selection input is from the first graphical button 178, at Step 166, a second graphical screen display 180 is provided that allows a pre-determined set of file transition rules to be created.

FIG. 14 is a block diagram illustrating a graphical screen display 180 for creating a pre-determined set of file transition rules. Graphical screen display 180 allows user to create file transition rules and graphically displays the file transition rule properties illustrated in Table 18 and creation of the exemplary file transition rules illustrated in Tables 10-16. However, the present invention is not limited to the fields displayed in graphical screen display 180, and more, fewer, or equivalent fields, and more or equivalent graphical screens can also be used. The Graphical screen display 180 illustrates creation of the file transition rule illustrated in Table 18.

TABLE 18

| | | File | Inc | | | | Prs |
|---|---|---|---|---|---|---|---|
| Source Path | Date | Size | Sub | Inc | Exc | Destination Path | Sub |
| % MYDOCUMENTS %/*.rtf | 04/17/00 | <1500 k | YES | X | | C:\RTF Documents | YES |

The exemplary rule in Table 18 specifies that all Microsoft Word files in Rich Text Format (“RTF”) files found in the source directory %MYDOCUMENTS%, including all sub-directories under this directory, that have a file size of 1.5 megabytes or less be included in the transition package. Additionally, the destination directory for the files is remapped to the c:\RTF Documents directory, preserving the original subdirectory structure on the target computing system 26.

Returning to FIG. 12B at Step 168, a test is conducted to determine if the selection input is for the second graphical button. If the selection input is from the second graphical button, at Step 170, a third graphical screen display 182 is presented that allows a predetermined a set of files to be selected from a directory hierarchy 142 (FIG. 10) on the source computing system 12.

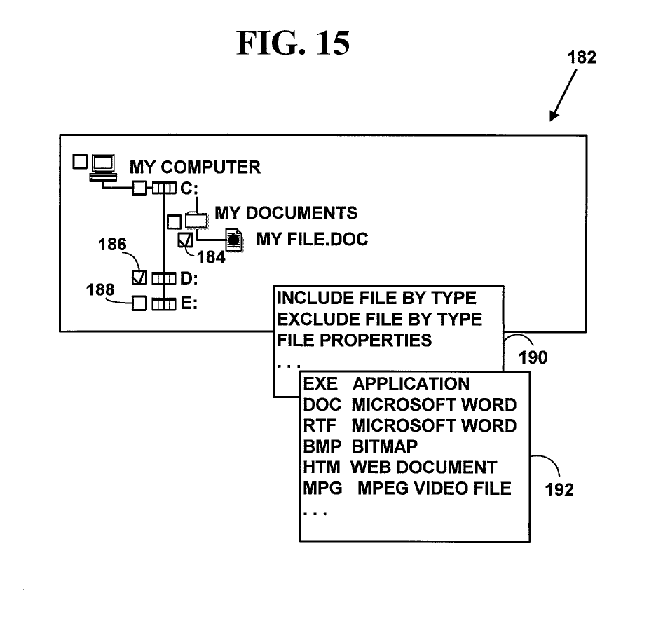

FIG. 15 is a block diagram illustrating a graphical screen display 182 for selecting files from a directory hierarchy. Graphical screen display 182 illustrates check-boxes 184, 186, 188 that are used to include (i.e., checked) or exclude (i.e., unchecked) in the directory hierarchy. For example, the file MY FILE.DOC is included in the transition with a checked check box 184. In addition, all files on disk drive D: are selected for inclusion in the transition with a checked box 186. In contrast, no files on disk drive E: are selected for inclusion (i.e., they are excluded) as is illustrated with unchecked check box 188. However, the present invention is not limited to the file selection mechanism illustrated in graphical screen display 182, and more, fewer, or equivalent file selection mechanisms can also be used.

To select all files from a part of hierarchical directory (My Computer, a Disk Drive, or a Folder) on down, a user checks the box next to that item. All eligible items subsidiary to (i.e., underneath) the checked item are automatically checked. To exclude all files from a hierarchical item on down, the user clears the checkbox next to that item. All eligible items subsidiary to (i.e., underneath) the cleared item are automatically cleared.

In order to select or exclude files by file type, on a hierarchical basis, the user selects (e.g., right-clicks on a mouse) a hierarchical item in a list box 190. The user chooses to either Include by File Type or Exclude by File Type. Once the user makes this choice, a dialog box 192 appears to allow a user to include/exclude files from the directory hierarchy by file type. However, the present invention is not limited to the graphical screen displays 182, 190 and 192, and more, fewer, or equivalent graphical screens displays can also be used.

Returning to FIG. 12B, at Step 172, a transition plan is prepared based on the accepted selected input. The transition plan is used to transition files from the source computing system 12 to the target computing system 26. The transition plan is used to transition files from the source computing system 12 to the target computing system 26. In one embodiment of the present invention, the transition plan is stored in a pre-determined database format for relational databases. However, non-relational database formats could also be used. However, other formats can also be used and the present invention is not limited to the database formats described.

The methods and system described herein provide an automated transition process for transition files from a target computing system to a host computing system. The method and system may vastly reduce transition, configuration and deployment times for service providers, corporations, and end-users for transitions from a target computing system to source computing system. The method and system may also save time, resources, improve transition quality, and lower user frustration.

It should be understood that the programs, processes, methods and systems described herein are not related or limited to any particular type of computer or network system (hardware or software), unless indicated otherwise. Various types of general purpose or specialized computer systems may be used with or perform operations in accordance with the teachings described herein.

In view of the wide variety of embodiments to which the principles of the present invention can be applied, it should be understood that the illustrated embodiments are exemplary only, and should not be taken as limiting the scope of the present invention. For example, the steps of the flow diagrams may be taken in sequences other than those described, and more, fewer or equivalent elements may be used in the block diagrams. While various elements of the preferred embodiments have been described as being implemented in software, in other embodiments hardware or firmware implementations may alternatively be used, and vice-versa.

The claims should not be read as limited to the described order or elements unless stated to that effect. Therefore, all embodiments that come within the scope and spirit of the following claims and equivalents thereto are claimed as the invention.

We claim:

1. A method for automatically transitioning files from a source computing system to a target computing system, comprising the steps of:
obtaining a pre-determined set of file transition rules on a Personality Object, wherein the pre-determined set of file transition rules allows files to be included or excluded from a transition based on one or more file parameters;
applying the pre-determined set of file transition rules to the source computing system from the Personality Object to extract a plurality of files from a plurality of locations on the source computing system;
preparing from the Personality Object a transition package in a pre-determined format including the plurality of extracted files, wherein the transition package is used to transition files from the source computing system to the target computing system.

2. A computer readable medium having stored therein instructions for causing a processor to execute the method of claim 1.

3. The method of claim 1 further comprising:
transferring the transition package to the target computing system;
infusing the transition package on the target computing system to transition files from the source computing system to the target computing system; and
optionally verifying infusion of the transition package to ensure that the extracted files have been correctly transitioned to the target computing system.

4. The method of claim 1 wherein the pre-determined set of file transition rules includes a rule property list, an order of precedence list, one or more pre-defined system variables or one or more static rules.

5. The method of claim 3 wherein the rule property list includes a source path property, an include subdirectories property, an include property, an exclude property, a date property, a file size property, a destination path property, or a preserve subdirectories property.

6. The method of claim 3 wherein the pre-defined system variables include my documents, windows, system, username, domain, my computer or desktop system variables.

7. The method of claim 1 wherein the pre-determined set of rules include exclude all, include all, exclude file type, include file type, include file type modified since a date, include all files in a directory, include all files in a directory including all sub-directories, include file type files in a directory, include selected file types in a directory including selected sub-directories, include files with selected file attributes, or exclude files with selected file attributes.

8. The method of claim 1 further comprising:
saving the pre-determined set of file transition rules in persistent storage on the source computing system or in the transition package.

9. The method of claim 1 wherein the step of applying the pre-determined set of file transition rules includes applying the pre-determined set of file transition rules using a precedence order.

10. The method of claim 1 wherein the pre-determined set of file transition rules allows a plurality of different files from a plurality of different source computing systems to be simultaneously transitioned with the transition package independent of actual locations of the plurality of different files in file systems on the plurality of source computing systems.

11. The method of claim 1 wherein the Personality Object includes an object-oriented control interface with a file rules control and a file tree control.

12. A method for automatically transitioning files from a source computing system to a target computing system, comprising the steps of:
obtaining on a Personality Object a list of a plurality files selected from a directory hierarchy on the source computing system to be transitioned to the target computing system;
extracting from the Personality Object using the list of files plurality of files from a plurality of locations in the directory hierarchy on the source computing system;
preparing from the Personality Object a transition package in a predetermined format including the plurality of extracted files, wherein the transition package is used to transition files from the source computing system to the target computing system.

13. A computer readable medium having stored therein instructions for causing a processor to execute the method of claim 12.

14. The method of claim 12 further comprising:
saving a list of extracted files in persistent storage on the source computing system or in the transition package.

15. The method of claim 12 further comprising:
transferring the transition package to the target computing system;
infusing the transition package on the target computing system to transition files from the source computing system to the target computing system; and
optionally verifying infusion of the transition package to ensure that the extracted files have been correctly transitioned to the target computing system.

16. The method of claim 12 wherein the directory hierarchy includes a directory, sub-directory, folder, sub-folder, disk drive or one or more types of files.

17. The method of claim 12 wherein the list of a plurality files selected from a directory hierarchy allows a plurality of different files from a source computing system to be transitioned with the transition package dependent on actual locations of the plurality of files in the directory hierarchy on the source computing system.

18. The method of claim 12 wherein the Personality Object including object-oriented control interface with a files rules control and a file tree control.

19. A method for automatically transitioning files from a source computing system to a target computing system, comprising the steps of:
obtaining on a Personality Object, a pre-determined set of file transition rules, wherein the predetermined set of file transition rules allows files to be included or excluded from a transition based on one or more file parameters;
obtaining on the Personality Object a list of a plurality files selected from a directory hierarchy on the source computing system to be transitioned to the target computing system;
determining from the Personality Object whether any files to be extracted using the pre-determined set of file transition rules conflict with any files from the list of plurality of files selected from the directory hierarchy, and if so,
extracting files from the source computing system using the pre-determined set of file transition rules whenever there is a conflict with the list of files selected from the directory hierarchy;
preparing from the Personality Object a transition package in a predetermined format including the plurality of extracted files, wherein the transition package is used to transition files from the source computing system to the target computing system.

20. A computer readable medium having stored therein instructions for causing a processor to execute the method of claim 19.

21. The method of claim 19 further comprising:
determining from the Personality Object whether any files extracted using the pre-determined set of file transition rules conflict with any files from the list of plurality of files selected from the directory hierarchy, and if not,
extracting files from the source computing system using either the pre-determined set of file transition rules or the list of files selected from the directory hierarchy.

22. The method of claim 19 further comprising:
transferring the transition package to the target computing system;
infusing the transition package on the target computing system to transition files from the source computing system to the target computing system; and
optionally verifying infusion of the transition package to ensure that the extracted files have been correctly transitioned to the target computing system.

23. The method of claim 19 wherein the determining step includes determining from the Personality Object whether any files extracted using the pre-determined set of file transition rules conflict with any files from the list of plurality of files selected from the directory hierarchy with an object-oriented control interface including a file rules control and a file tree control, wherein file transition rules used by the file rules control are enforced on usage of the file tree control and preempt processing of files selected from a directory hierarchy by the file tree control.

24. The method of claim 19 wherein the predetermined set of file transition rules allows a plurality of different files to be transitioned with the transition package independent of the actual locations of the plurality of different files in directory structures on the source computing system and the

25. The method of claim 19 wherein the list of a plurality files selected from a directory hierarchy allows a plurality of different files from a source computing system to be transitioned with the transition package dependent on the actual locations of the plurality of files in the directory hierarchy on the source computing system.

26. A method for selecting files automatically transitioned from a source computing system to a target computing system, comprising the steps of:
providing from a first graphical screen display on a graphical user interface, wherein the first graphical screen display allows a predetermined set of files transition rules to be created by selecting a first graphical button and allows a list of files to be selected from a directory hierarchy on the source computing system by selecting a second graphical button;
accepting a selection input on the graphical user interface from the first graphical button or the second graphical button;
determining if the selection input is for the first graphical button, and if so,
providing a second graphical screen display that allows a predetermined set of file transition rules to be created;
determining if the selection input is for the second graphical button, and if so,
providing a third graphical screen display that allows a pre-determined a set of files to be selected from a directory hierarchy on the source computing system; and
preparing a transition plan based on the accepted selected input, wherein the transition plan is used to transition files from the source computing system to the target computing system.

27. A computer readable medium having stored therein instructions for causing a processor to execute the method of claim 26.

28. The method of claim 26 wherein the transition plan includes both a pre-determined set of files transition rules and a list of files from a directory hierarchy accepted based on the accepted selected input.

29. The method of claim 26 wherein the transition plan includes only a pre-determined set of file transition rules or a list of file from a directory hierarchy accepted based on the accepted selected input.

30. The method of claim 26 wherein the second graphical screen display and the third graphical screen displays includes a plurality of other graphical screens to accept inputs from a user.

31. A file transition system, comprising in combination:
a Personality Object for obtaining a pre-determined set of file transition rules, wherein the pre-determined set of file transition rules allows files to be included or excluded from a transition based on one or more file parameters, obtaining a list of a plurality files from a directory hierarchy to be transitioned to a target computing system, extracting using the list of files, a plurality of files from a plurality of locations in the directory hierarchy on a source computing system, applying the predetermined set of file transition rules to the source computing system to extract a plurality of files from a plurality of locations on the source computing system, preparing a transition package in a predetermined format including the plurality of extracted files, wherein the transition package is used to transition files from the source computing system to the target computing system;
a predetermined set of file transition rules for extracting a plurality of files from a plurality of locations on the source computing system; and
a list of a plurality files selected from a directory hierarchy for extracting files from the directory hierarchy on the source computing system.

32. The system of claim 31 further comprising:
a graphical user interface for accepting, editing and saving a predetermined set of file transition rules or a list plurality of files from a directory hierarchy used to transition files from the source computing system to the target computing system.

33. The system of claim 31 wherein the Personality Object includes an object-oriented control interface with a file rules control and a file tree control.

34. The system of claim 31 wherein the object-oriented control interface is an ActiveX based Component Object Model (COM) control.

35. The system of claim 31 wherein the file rules control and file tree control are ActiveX based-controls.

36. The system of claim 31 further comprising:
An extraction application for using a pre-determined set of file transition rules or a list a plurality of files from a directory hierarchy to transition files from the source computing system to the target computing system.
